(19) United States
(12) Patent Application Publication
(10) Pub. No.: US 2014/0063545 A1
(43) Pub. Date: Mar. 6, 2014

(54) SERVER DEVICE, INFORMATION PROCESSING METHOD, AND COMPUTER PROGRAM PRODUCT

(71) Applicants: Masato Takahashi, Tokyo (JP); Yohei Ando, Kanagawa (JP); Yuya Akimoto, Tokyo (JP)

(72) Inventors: Masato Takahashi, Tokyo (JP); Yohei Ando, Kanagawa (JP); Yuya Akimoto, Tokyo (JP)

(21) Appl. No.: 14/013,528

(22) Filed: Aug. 29, 2013

(30) Foreign Application Priority Data
Sep. 5, 2012 (JP) 2012-195527

(51) Int. Cl. G06F 3/12

(52) U.S. Cl. CPC G06F 3/1293
USPC 358/1.15

(57) ABSTRACT

A server device includes: an acquisition unit that acquires, from a first information processing apparatus that is connected via a network, identification information on a second information processing apparatus that is connected via a network and that is an object to be remotely controlled; a storage unit that previously stores the identification information on the second information processing apparatus and a program for remotely controlling the second information processing apparatus associated with each other; and an execution unit that executes the program that is related to the acquired identification information, wherein the execution unit includes: a receiving unit that receives, from the first information processing apparatus, a control signal for controlling the second information processing apparatus that is identified by the acquired identification information; and a transmitting unit that transmits the received control signal to the second information processing apparatus that is identified by the acquired identification information.

### CROSS-REFERENCE TO RELATED APPLICATIONS

The present application claims priority to and incorporates by reference the entire contents of Japanese Patent Application No. 2012-195527 filed in Japan on Sep. 5, 2012.

### BACKGROUND OF THE INVENTION

1. Field of the Invention

The present invention relates to a server device, an information processing method, and a computer program product.

2. Description of the Related Art

Conventionally, data is transmitted from a network-connected information processing apparatus and is then transmitted via a server to a printer that is designated by the information processing apparatus. Furthermore, in the server, the data received from the information processing apparatus is converted into a data format printable by the printer and is then transmitted to the designated information processing apparatus.

In terms of improvement in the operability, Japanese Patent Application Laid-open No. 2007-109208 discloses a technology in which the physical locations and statuses of printers are displayed so that a user is able to select, from the list of printers displayed, a printer that is an object to output the data.

However, according to Japanese Patent Application Laid-open No. 2007-109208, only data transmission from one information processing apparatus to another information processing apparatus, which is an object to be operated, via a server is performed, and the operation on the data transferred from one information processing apparatus to another information processing apparatus, which is an object to be operated, or the control on another information processing apparatus is difficult. That is, it is conventionally difficult to, by using one information processing apparatus, remotely control another information processing apparatus, which is an operation object, in an easy and simple operation.

Therefore, it is desirable to provide a server device, an information processing method, and a computer program product by which it is possible to, by using one information processing apparatus, remotely control another information processing apparatus, which is an operation object, in an easy and simple operation.

### SUMMARY OF THE INVENTION

It is an object of the present invention to at least partially solve the problems in the conventional technology.

According to an aspect of the present invention, there is provided a server device including: an acquisition unit that acquires, from a first information processing apparatus that is connected via a network, identification information on a second information processing apparatus that is connected via a network and that is an object to be remotely controlled; a storage unit that previously stores the identification information on the second information processing apparatus and stores a program for remotely controlling the second information processing apparatus that is identified by the identification information, the identification information being related to the program; and an execution unit that executes the program that is related to the acquired identification information, wherein the execution unit includes: a receiving unit that receives, from the first information processing apparatus, a control signal for controlling the second information processing apparatus that is identified by the acquired identification information; and a transmitting unit that transmits the received control signal to the second information processing apparatus that is identified by the acquired identification information.

According to another aspect of the present invention, there is provided an information processing method performed by a server device, the method including: acquiring, from a first information processing apparatus that is connected via a network, identification information on a second information processing apparatus that is connected via a network and that is an object to be remotely controlled; and executing a program that is related to the acquired identification information, the program being in a storage unit that previously stores the identification information on the second information processing apparatus and stores the program for remotely controlling the second information processing apparatus that is identified by the identification information, and the identification information being related to the program, the executing includes: receiving, from the first information processing apparatus, a control signal for controlling the second information processing apparatus that is identified by the acquired identification information; and transmitting the received control signal to the second information processing apparatus that is identified by the acquired identification information.

According to still another aspect of the present invention, there is provided a computer program product including a non-transitory computer-readable medium having computer readable program codes, performed by a server device, the program codes when executed causing the server device to execute: acquiring, from a first information processing apparatus that is connected via a network, identification information on a second information processing apparatus that is connected via a network and that is an object to be remotely controlled; and executing a program that is related to the acquired identification information, the program being in a storage unit that previously stores the identification information on the second information processing apparatus and stores the program for remotely controlling the second information processing apparatus that is identified by the identification information, and the identification information being related to the program, wherein the executing includes: receiving, from the first information processing apparatus, a control signal for controlling the second information processing apparatus that is identified by the acquired identification information; and transmitting the received control signal to the second information processing apparatus that is identified by the acquired identification information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic view of an information processing system according to the present embodiment;

FIG. 2 is a system configuration diagram of the information processing system;

FIGS. 3A to 3D are diagrams that illustrate an example of the data structure of data stored in a storage unit;

FIG. 4 is a flowchart that illustrates an example of the steps of information processing performed by a first information processing apparatus;

FIG. 5 is a schematic diagram that illustrates an example of the image displayed on a display unit;

FIG. 6 is a schematic diagram that illustrates a state where a second information processing apparatus is selected;

FIG. 7 is a schematic diagram that illustrates a location screen;

FIG. 8 is a schematic diagram that illustrates an example of an input screen;

FIG. 9 is a schematic diagram that illustrates an example of a setting screen;

FIG. 10 is a schematic diagram that illustrates an example of an input screen;

FIG. 11 is a schematic diagram that illustrates an example of an input screen;

FIG. 12 is a schematic diagram that illustrates an example of a screen that is displayed on the display unit;

FIG. 13 is a flowchart that illustrates an example of the steps of information processing performed by a server device;

FIG. 14 is a schematic diagram that illustrates a state where a pop-up screen is displayed on the display unit;

FIG. 15 is a schematic diagram that illustrates a state where a pop-up screen is displayed on the display unit;

FIG. 16 is a schematic diagram that illustrates an example of the image displayed on the display unit;

FIG. 17 is a schematic diagram that illustrates an example of the image displayed on the display unit;

FIG. 18 is a flowchart that illustrates the steps of a retrieval process performed by a power feeding device;

FIG. 19 is a flowchart that illustrates the steps of information processing performed by the power feeding device; and

FIG. 20 is a flowchart that illustrates the steps of information processing performed by the second information processing apparatus.

### DETAILED DESCRIPTION OF THE PREFERRED EMBODIMENTS

An embodiment of a server device, an information processing method, and an information processing program is explained in detail below with reference to the accompanying drawings.

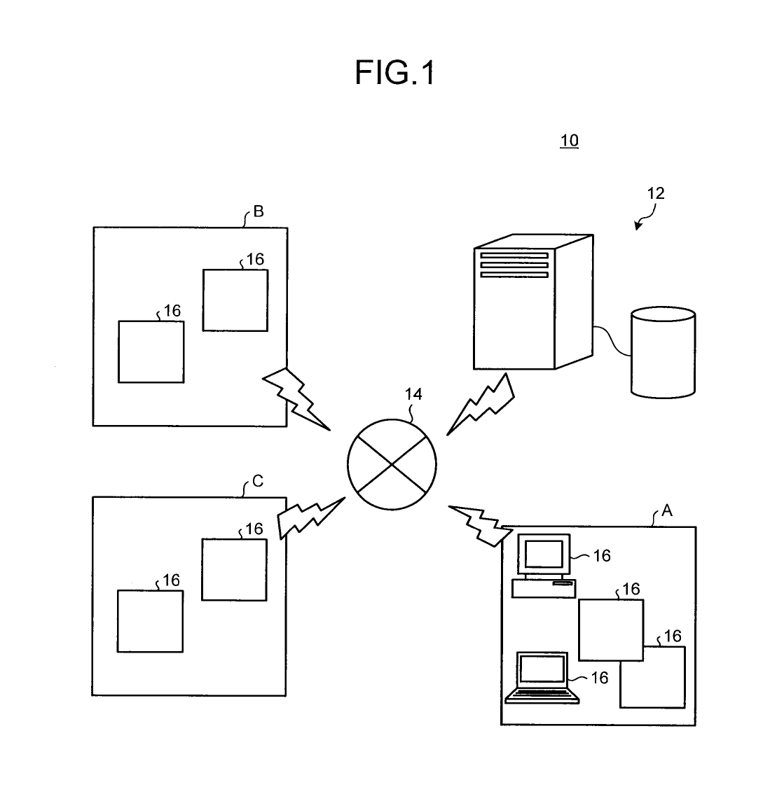

FIG. 1 is a schematic view of an information processing system 10 according to the present embodiment.

In the information processing system 10, a plurality of information processing apparatuses 16 is connected to a server device 12 via a network 14.

The network 14 is a known communication line. The network 14 may be a wired communication network or wireless communication network. The network 14 is, for example, the local area network (LAN) or the Internet.

The information processing apparatus 16 is an apparatus that performs various functions. Furthermore, the information processing apparatus 16 is an apparatus that remotely controls another information processing apparatus 16 via the server device 12 (a detailed explanation will be given later).

The information processing apparatus 16 is, for example, a personal computer (PC), mobile terminal (e.g., smartphone), image forming apparatus, image display apparatus, video-conference device, or the like. The image forming apparatus is an apparatus that has at least one of the printer function, the fax function, and the scanner function to form images. The image display apparatus is a known apparatus that displays images. The image display apparatus is, for example, a projector. The video-conference device is a known video-conference device. The video-conference device is a device that transmits/receives and outputs images and sounds to and from the information processing apparatus 16 via the network 14.

The information processing apparatuses 16 included in the information processing system 10 may be installed in the same location or may be installed in separate locations. In the present embodiment, an explanation is given of a case where the information processing apparatuses 16 included in the information processing system 10 are spread out such that one or more information processing apparatuses 16 are located in each of an area B of the shop, or the like, an area C of the user's house, or the like, and an area A of the user's office, or the like.

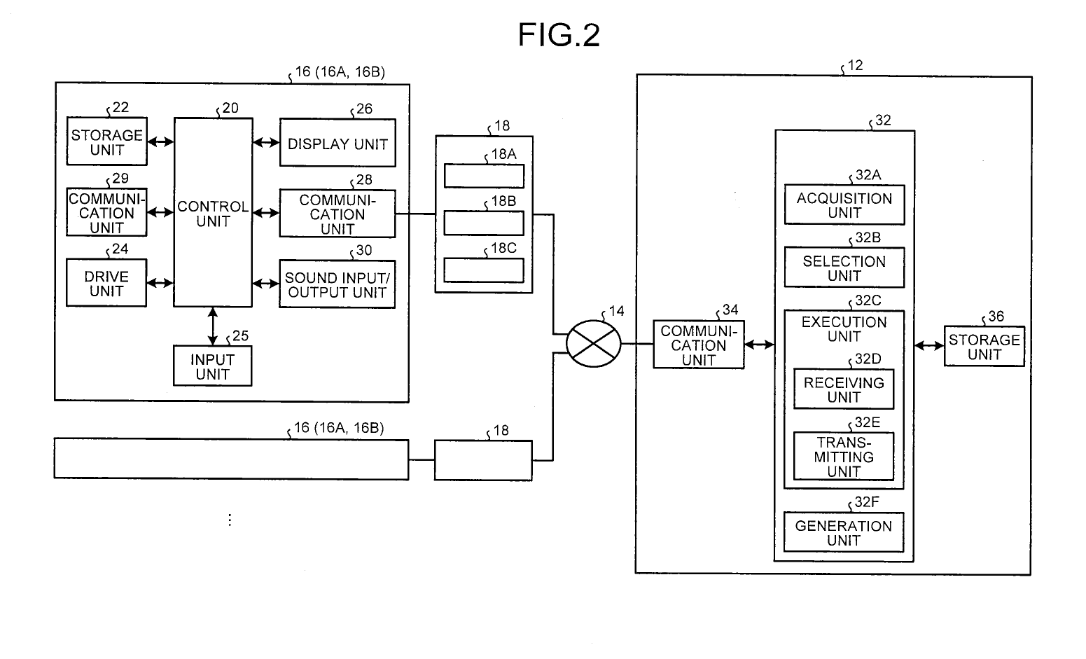

FIG. 2 is a system configuration diagram of the information processing system 10.

The information processing apparatus 16 includes a control unit 20, a storage unit 22, a communication unit 29, a drive unit 24, an input unit 25, a display unit 26, a communication unit 28, and a sound input/output unit 30.

The communication unit 28 is an interface that performs communication with the server device 12 via a power feeding device 18 and the network 14. The display unit 26 displays various types of information, such as a display screen. The display unit 26 is a known display device, such as a liquid crystal display (LCD).

The input unit 25 receives operation instructions, or the like, for various types of information, from users. The input unit 25 is, for example, a sound recognition device, such as a microphone, mouse, button, remote controller, keyboard, or the like. The input unit 25 and the display unit 26 may be integrally formed.

The sound input/output unit 30 inputs and outputs sound.

The storage unit 22 is a storage medium, such as a hard disk drive (HDD). The storage unit 22 stores various types of information. The communication unit 29 is an interface that performs short-range communication with another information processing apparatus 16 that is located near the information processing apparatus 16. A known device that performs short-range infrared communication is used as the communication unit 28.

The drive unit 24 drives a functional unit for each function that is executable in the information processing apparatus 16. For example, if the information processing apparatus 16 is an image forming apparatus, the drive unit 24 drives an image forming unit (not illustrated) that is installed in the information processing apparatus 16 and that forms images on a recording medium. If the information processing apparatus 16 is a display device, such as a projector, the control unit 20, instead of the drive unit 24, drives the display unit 26.

The control unit 20 is a computer that includes a central processing unit (CPU), a read only memory (ROM), a random access memory (RAM), or the like, and it performs overall control of the information processing apparatus 16.

In the explanation of the information processing system 10 according to the present embodiment, among the information processing apparatuses 16 included in the information processing system 10, the information processing apparatus 16 that remotely controls another information processing apparatus 16 is referred to as a first information processing apparatus 16A. Furthermore, in the explanation, the information processing apparatus 16 that is remotely controlled by the first information processing apparatus 16A is referred to as a second information processing apparatus 16B.

The power feeding device 18 is connected to the server device 12 via the network 14. The power feeding device 18 is a device that feeds the electric power to the connected information processing apparatus 16. In the present embodiment, an explanation is given of a case where the single information processing apparatus 16 is connected to the single power feeding device 18. Multiple information processing apparatuses 16 may be connected to the single power feeding device 18. The power feeding device 18 and the information processing apparatus 16 are connected to each other via a known wired or wireless communication line. The communication line is, for example, a network; however, this is not a limitation.

The power feeding device 18 is a computer that includes a central processing unit (CPU), a read only memory (ROM), a random access memory (RAM), or the like. The power feeding device 18 feeds the electric power to the connected information processing apparatus 16.

The power feeding device 18 includes a storage unit 18A, a control unit 18B, and a communication unit 18C.

The control unit 18B controls the power feeding device 18. The communication unit 18C is an interface that performs communication with the connected information processing apparatus 16 and the server device 12 that is connected via the network 14.

The storage unit 18A is a storage medium, such as a hard disk drive (HDD). The storage unit 18A stores various types of information. In the present embodiment, the storage unit 18A stores fourth data. The fourth data is a table that relates the positional information on the power feeding device 18, the identification information on the connected information processing apparatus 16, and the time in which the electric power is fed to the connected information processing apparatus 16.

If the power feeding device 18 is a device that is fixed in use, the positional information (e.g., the latitude and longitude) on the power feeding device 18 may be determined in advance and be stored in the storage unit 18A. If the power feeding device 18 is a mobile device that can be variably positioned, a configuration may be such that a known global positioning system (GPS) is installed in the power feeding device 18. The positional information on the power feeding device 18 may be determined by using the GPS at predetermined time intervals and the positional information stored in the storage unit 18A may be updated.

The power feeding device 18 stores, as the power feeding time, the continuous power feeding time that starts from the time when the power feeding to the connected information processing apparatus 16 is started, and updates the power feeding time as the continuous power feeding time elapses. Furthermore, when the power feeding to the connected information processing apparatus 16 is stopped, the power feeding device 18 stores the information indicating that the power feeding is stopped in a storage unit (not illustrated), the information being related to the identification information on the information processing apparatus 16.

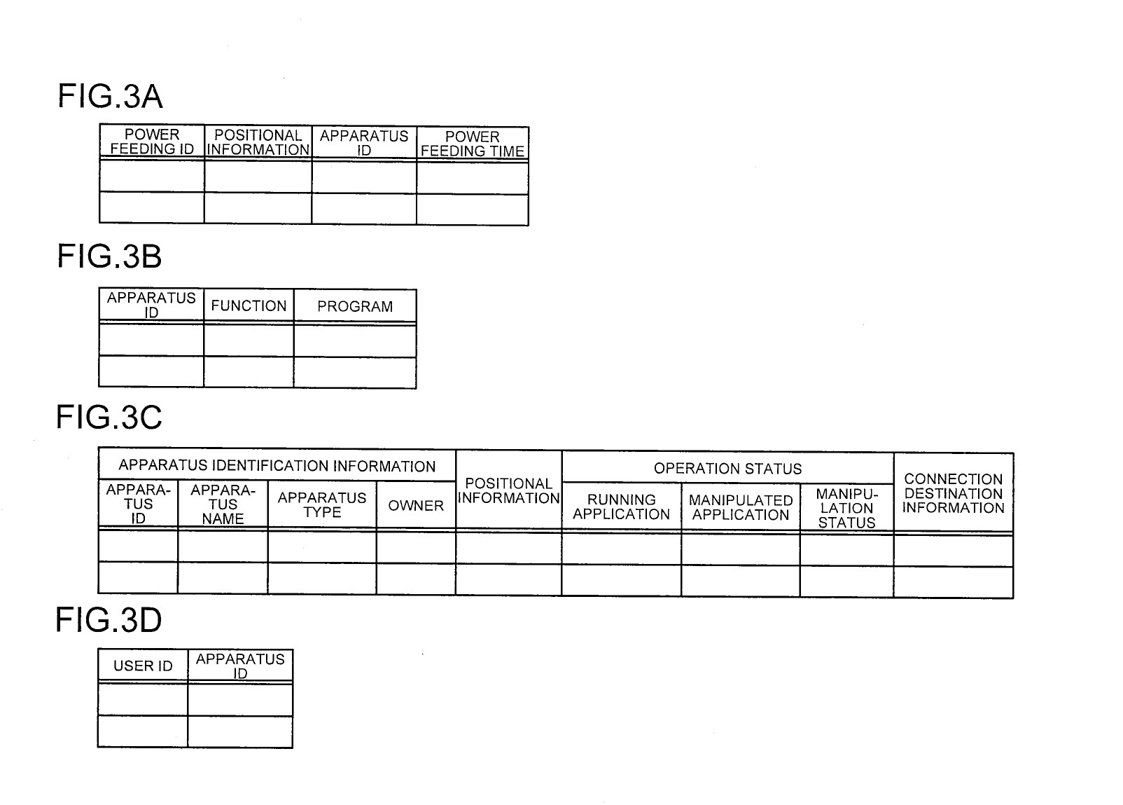

FIG. 3A is a diagram that illustrates an example of the data structure of the fourth data stored in the storage unit 18A. As illustrated in FIG. 3A, the storage unit 18A stores, in a related manner, the power feeding ID that is the identification information on the power feeding device 18, the positional information on the power feeding device 18, the apparatus ID that is the identification information on the information processing apparatus 16 connected to the power feeding device 18, and the power feeding time of the information processing apparatus 16.

With reference back to FIG. 2, the server device 12 includes a control unit 32, a communication unit 34, and a storage unit 36.

The communication unit 34 is an interface for performing communication between the information processing apparatus 16 and the server device 12 via the network 14.

The storage unit 36 is a storage medium, such as a hard disk drive (HDD). The storage unit 36 stores various types of information.

According to the present embodiment, the storage unit 36 stores various types of information, such as first data, second data, and third data.

The first data is a table that relates the identification information on the information processing apparatus 16 in the information processing system 10, the function executable by the information processing apparatus 16, and the program for causing the information processing apparatus 16 to execute the function so as to remotely control the information processing apparatus 16 by using another information processing apparatus 16.

The identification information on the information processing apparatus 16 in the information processing system 10 is the identification information for uniquely identifying the information processing apparatus 16 that is the management object in the information processing system 10. The function executable by the information processing apparatus 16 indicates various types of operations that are executable by the information processing apparatus 16. The function executable by each of the information processing apparatuses 16 varies depending on the configuration of the information processing apparatus 16.

If the information processing apparatus 16 is, for example, an image forming apparatus, the function executable by the information processing apparatus 16 is, for example, to form an image corresponding to the image data, to change or set various types of setting information at the time of forming an image. If the information processing apparatus 16 is a projector, the function executable by the information processing apparatus 16 is, for example, to display an image on the image data that is an object to be displayed, to enlarge the displayed image, to reduce the displayed image, to change the page of the displayed image, to change or set various types of setting information at the time of displaying an image.

The program for causing the information processing apparatus 16 to execute the function so as to remotely control the information processing apparatus 16 by using another information processing apparatus 16 is, in other words, the program for controlling the corresponding information processing apparatus 16. This program is executed by the server device 12. Specifically, the program includes the function to receive, from the first information processing apparatus 16A, the control signal that includes the instruction information for causing the corresponding information processing apparatus 16 to execute a function that is executable by the information processing apparatus 16 and to cause the corresponding second information processing apparatus 16B to execute the process that corresponds to the received control signal. Furthermore, the program executes the function to receive, from the information processing apparatus 16, the execution status information (a detailed explanation will be given later) with respect to the control signal transmitted from the server device 12 to the information processing apparatus 16.

The instruction information included in the control signal varies depending on the function executable by the information processing apparatus 16. For example, if the information processing apparatus 16 is an image forming apparatus, the control signal includes, as the instruction information, the image data that is an object to be formed, the instruction to form an image in accordance with the image data, the setting information at the time of forming an image, or the like. Furthermore, if the information processing apparatus 16 is a projector, the control signal includes, as the instruction information, the image data that is an object to be displayed, the instruction to display an image on the image data, to enlarge the displayed image, to reduce the displayed image, or to change the page (turn over the page or turn back the page) of the displayed image, the setting information at the time of displaying an image, or the like.

FIG. 3B is a schematic diagram that illustrates an example of the data structure of the first data. As illustrated in FIG. 3B, the first data is a table that relates the apparatus ID that is the identification information on the information processing apparatus 16 in the information processing system 10, the function executable by the information processing apparatus 16, and the program for remotely controlling the information processing apparatus 16 by using another information processing apparatus 16. In the following explanation, the identification information on the information processing apparatus 16 in the information processing system 10 is sometimes referred to as the apparatus ID.

FIG. 3C is a schematic diagram that illustrates an example of the data structure of the second data.

The second data is a table that relates the apparatus identification information on the information processing apparatus 16 in the information processing system 10, the positional information on the information processing apparatus 16, the operation status of the information processing apparatus 16, and the connection destination information.

The apparatus identification information is the information by which the information processing apparatus 16 can be identified. In the present embodiment, the apparatus identification information includes the apparatus ID (the identification information on the information processing apparatus 16), the name of the apparatus, the type of apparatus, the owner, or the like.

The name of the apparatus is the name that is assigned to the information processing apparatus 16 and by which the user can identify the information processing apparatus 16. The name of the apparatus is, for example, “G mobile phone” (G indicates the name of a person), “the image forming apparatus in the department H”, “the projector in the conference room I”, or the like.

The type of apparatus is the information that indicates the type of information processing apparatus 16. The type of information processing apparatus 16 is the information that is assigned in advance to each function or configuration of the information processing apparatus 16. The type of apparatus is, for example, a mobile terminal, smartphone, projector, multifunction peripheral, or the like.

The owner is the information that indicates the owner of the corresponding information processing apparatus 16. The owner is, for example, “G” (G indicates the name of a person), “the conference room I”, or the like.

The positional information included in the second data is the information that indicates the position of each of the information processing apparatuses 16. The server device 12 stores, in the storage unit 36 and as the positional information on the information processing apparatus 16, the positional information on the power feeding device 18 that is connected to the information processing apparatus 16. If a configuration is such that the information processing apparatus 16 has the GPS installed therein, the positional information on the information processing apparatus 16 is determined by the information processing apparatus 16 using the GPS and it may be stored in the storage unit 36. Furthermore, if the information processing apparatus 16 is located at a position where it can perform short-range communication with another information processing apparatus 16, the positional information on another information processing apparatus 16 or the positional information on the power feeding device 18 connected to another information processing apparatus 16 may be stored in the storage unit 36 as the positional information on the subject information processing apparatus 16.

When the server device 12 receives a location-screen (which will be explained later) acquisition request from the first information processing apparatus 16A, the server device 12 acquires the positional information on each of the information processing apparatuses 16 from at least one of the information processing apparatus 16 and the power feeding device 18 and then updates the second data in the storage unit 36. The server device 12 may acquire the positional information on each of the information processing apparatuses 16 from at least one of the information processing apparatus 16 and the power feeding device 18 at predetermined time intervals and then update the second data in the storage unit 36. Furthermore, the server device 12 may acquire the fourth data from the power feeding device 18 at predetermined time intervals and store it in the storage unit 36.

FIG. 3D is a schematic diagram that illustrates an example of the data structure of the third data. As illustrated in FIG. 3D, the third data is a table that relates the user ID and the apparatus ID.

The third data is a table that relates the user ID that is the identification information on the user who operates the information processing apparatus 16 to the identification information (the apparatus ID) on the information processing apparatus 16 that is operated by the user who is identified by the user ID.

When the information processing apparatus 16 is started up, or when various operation requests are received from each of the information processing apparatuses 16, the server device 12 reads the user ID and the apparatus ID that are included in the signal received from the information processing apparatus 16 and then stores them in the storage unit 36 as the third data.

With reference back to FIG. 2, the control unit 32 includes an acquisition unit 32A, a selection unit 32B, an execution unit 32C, and a generation unit 32F.

The generation unit 32F generates the location screen in which a first image indicating each of the information processing apparatuses 16 is located at the position that corresponds to the positional information on the information processing apparatus 16 in the real space. For example, the generation unit 32F prepares the map information, layout, or the like, of each area that is an object managed by the information processing system 10 and locates the prepared first image, which indicates each of the information processing apparatuses 16, at a position on the map information or layout, the position corresponding to the positional information on the information processing apparatus 16 in the real space. Thus, the location screen is generated. The generation unit 32F may use, as the positional information on each of the information processing apparatuses 16 in the real space, the positional information that is included in the second data stored in the storage unit 36. Furthermore, the image by which the user can identify each apparatus may be prepared in advance as the first image for each apparatus type or each apparatus ID of the information processing apparatuses 16 and it may be stored in the storage unit 36.

The location screen may include information about the information processing apparatus 16 that corresponds to each of the first images. Specifically, the location screen may include, as the information about the information processing apparatus 16, at least one of the apparatus ID of the information processing apparatus 16 that corresponds to the first image, the apparatus identification information, the operation status, the positional information, the power feeding ID of the connected power feeding device 18, and the power feeding time.

The acquisition unit 32A acquires, from the first information processing apparatus 16A, the identification information on the second information processing apparatus 16B that is a remotely controlled object. Although a detailed explanation will be given later, the control unit 32 transmits the location screen to the first information processing apparatus 16A via the communication unit 34. When the first image of the second information processing apparatus 16B on the location screen is selected in accordance with the user's operation instruction via the input unit 25 of the first information processing apparatus 16A, the identification information on the second information processing apparatus 16B that corresponds to the selected first image is transmitted to the server device 12 as the identification information on the second information processing apparatus 16B that is a remotely operated object. Thus, the acquisition unit 32A acquires, from the first information processing apparatus 16A, the identification information (the apparatus ID) on the second information processing apparatus 16B that is a remotely operated object. There is no limitation on the configuration in which the acquisition unit 32A acquires the identification information from the single second information processing apparatus 16B. The acquisition unit 32A may acquire the identification information on the multiple second information processing apparatuses 16B.

The selection unit 32B selects the program that is related to the apparatus ID that is acquired by the acquisition unit 32A. Specifically, the selection unit 32B reads, from the first data in the storage unit 36, the program that is related to the apparatus ID acquired by the acquisition unit 32A.

The execution unit 32C executes the program selected by the selection unit 32B. When the execution unit 32C executes the program, the server device 12 enters a state where it can receive a control signal from the first information processing apparatus 16A and it can cause the corresponding second information processing apparatus 16B to perform the operation in accordance with the received control signal.

The execution unit 32C includes a receiving unit 32D and a transmitting unit 32E. When the execution unit 32C executes the program selected by the selection unit 32B, the receiving unit 32D and the transmitting unit 32E are loaded into and generated in the main storage device.

The receiving unit 32D receives a control signal from the first information processing apparatus 16A. Furthermore, the receiving unit 32D receives, from the second information processing apparatus 16B, the execution status information with respect to the control signal that has been transmitted from the transmitting unit 32E to the second information processing apparatus 16B.

The execution status information is the information that indicates the execution status of the operation that is performed by the second information processing apparatus 16B in response to the control signal.

The transmitting unit 32E transmits the control signal received from the first information processing apparatus 16A to the second information processing apparatus 16B that is identified by the identification information (the apparatus ID) acquired by the acquisition unit 32A.

In the information processing system 10 according to the present embodiment, among the information processing apparatuses 16 included in the information processing system 10, the first information processing apparatus 16A, which requests another information processing apparatus 16 to execute a function, remotely controls another second information processing apparatus 16B that is connected to the network 14.

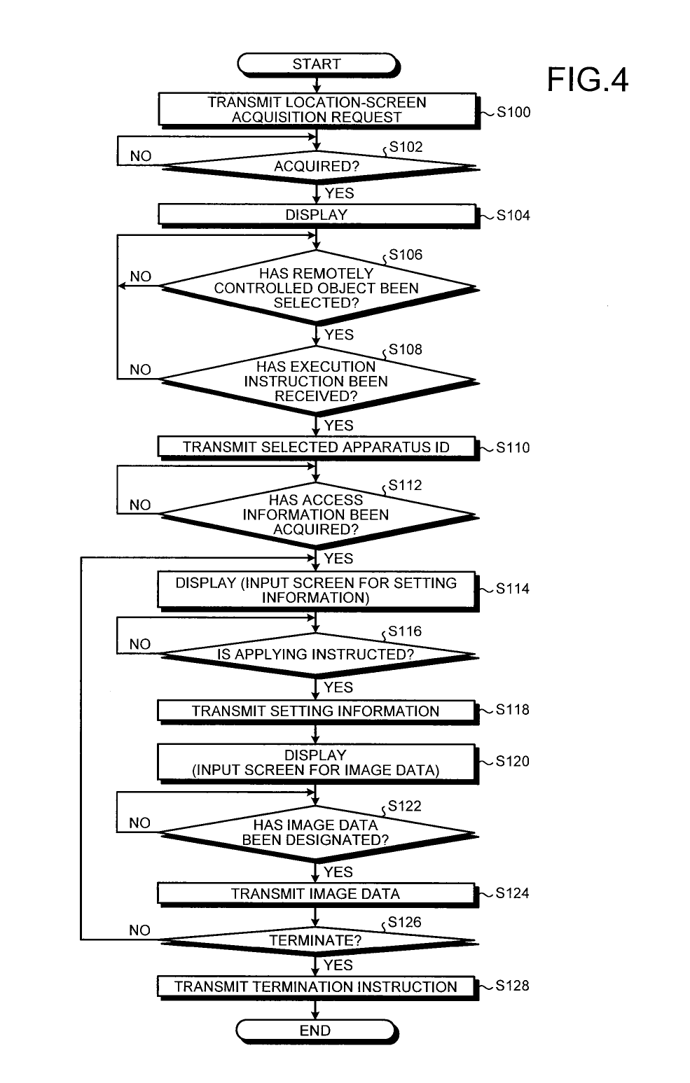

First, an explanation is given of the steps of the information processing performed by the first information processing apparatus 16A. An explanation is given below (i.e., in FIGS. 4 to 20) of a case where, for example, the first information processing apparatus 16A is a PC and the second information processing apparatus 16B is a projector. Furthermore, an explanation is given of a case where each of the information processing apparatuses 16 is connected to the server device 12 via the power feeding device 18.

FIG. 4 is a flowchart that illustrates an example of the steps of the information processing performed by the first information processing apparatus 16A.

First, the control unit 20 in the first information processing apparatus 16A transmits the location-screen acquisition request to the server device 12 (Step S100). Next, the control unit 20 determines whether the location screen has been acquired from the server device 12 via the power feeding device 18 (Step S102). At Step S102, a negative determination is repeated (Step S102: No) until a positive determination is made (Step S102: Yes). If a positive determination is made at Step S102 (Step S102: Yes), the process proceeds to Step S104.

At Step S104, the control unit 20 performs control so as to display, on the display unit 26, the location screen acquired from the server device 12 (Step S104).

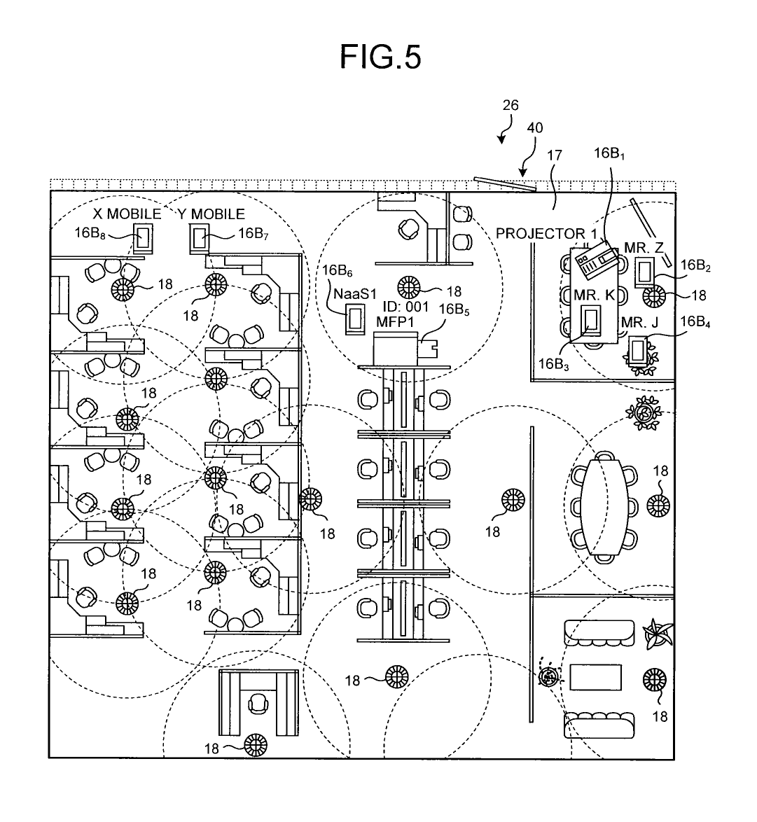

FIG. 5 is a schematic diagram that illustrates an example of the image displayed on the display unit 26 after the operation is performed at the above-described Step S104.

As illustrated in FIG. 5, a location screen 40 is displayed on the display unit 26. As illustrated in FIG. 5, the location screen 40 includes the image in which the first image is located at a position in a layout 17, the first image indicating each of the second information processing apparatuses 16B (second information processing apparatus 16B₁ to second information processing apparatus 16B₈) that are connected to the server device 12 in the information processing system 10, and the position corresponding to the positional information on the second information processing apparatuses 16B. Moreover, in the example illustrated in FIG. 5, a second image indicating each of the power feeding devices 18 is located at a position in the layout 17, the position corresponding to the positional information on the power feeding devices 18. In FIG. 5, the dotted lines indicate the area to which the power feeding device 18 is capable of supplying the electric power.

With reference back to FIG. 4, next, the control unit 20 determines whether a remotely controlled object has been selected (Step S106). For example, the control unit 20 determines whether, among the first images included in the location screen displayed on the display unit 26 at Step S104, one or more first images have been selected in accordance with the user's operation instruction via the input unit 25, thereby making a determination at Step S106.

At Step S106, a negative determination is repeated (Step S106: No) until a positive determination is made (Step S106: Yes). If a positive determination is made at Step S106 (Step S106: Yes), the process proceeds to Step S108.

At Step S108, the control unit 20 determines whether the execution instruction has been received (Step S108). The control unit 20 determines whether a signal has been received from the input unit 25 in accordance with the user's operation instruction via the input unit 25, the signal indicating that the second information processing apparatus 16B having the apparatus ID that corresponds to the first image selected at Step S106 is determined to be an object to be remotely controlled, thereby making a determination at Step S108.

If a positive determination is made at Step S108 (Step S108: Yes), the process proceeds to Step S110. At Step S110, the apparatus ID of the second information processing apparatus 16B is transmitted to the server device 12, the second information processing apparatus 16B corresponding to the first image of the remotely controlled object selected at Step S106 (Step S110).

The location screen includes the apparatus ID of the second information processing apparatus 16B that corresponds to the first image included in the location screen. Therefore, the control unit 20 may read, from the location screen, the apparatus ID that corresponds to the selected first image and may transmit it to the server device 12.

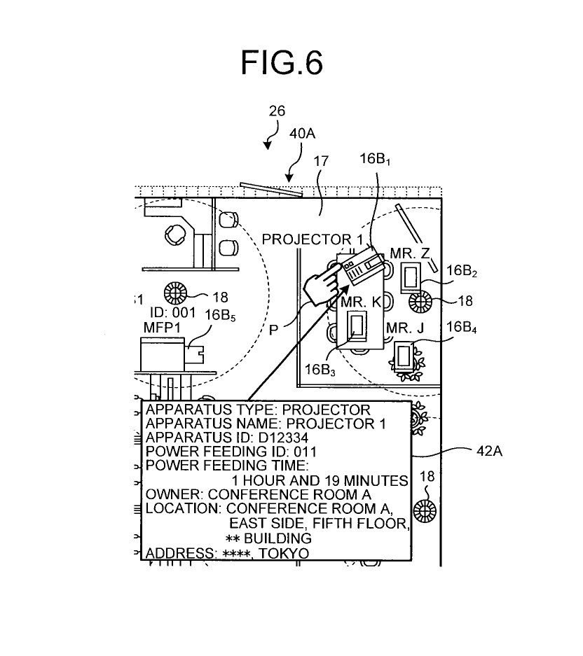

FIG. 6 is a schematic diagram that illustrates a state where the second information processing apparatus 16B₁ is selected in accordance with the user's operation instruction via the input unit 25 during the operation at the above-described Step S106.

As illustrated in FIG. 6, in accordance with the user's operation instruction via the input unit 25, a pointer P is located at the display location of the second information processing apparatus 16B₁ (projector 1) on a location screen 40A so that the second information processing apparatus 16B₁ is selected. In this case, the control unit 20 displays, on the display unit 26, a window 42A that indicates the information about the second information processing apparatus 16B₁ that is included in the location screen.

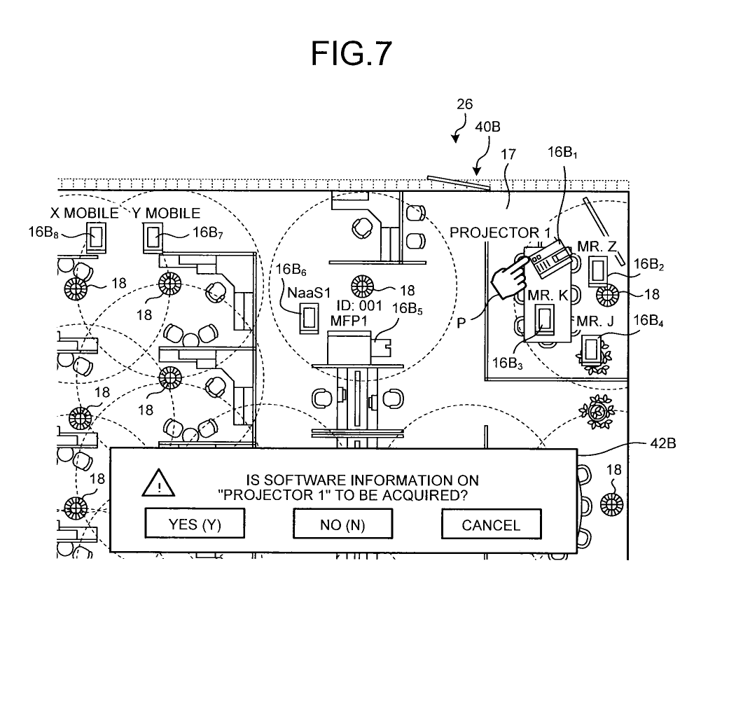

FIG. 7 is a schematic diagram that illustrates the location screen 40 (a location screen 40B) when the execution instruction is to be input in accordance with the user's operation instruction via the input unit 25 during the operation at the above-described Step S108.

As illustrated in FIG. 7, when the second information processing apparatus 16B (e.g., the second information processing apparatus 16B₁ (projector 1)) is selected during the operation at the above-described Step S106, the control unit 20 displays, on the display unit 26, a window 42B to prompt the selection of whether an instruction is to be given to execute the selected second information processing apparatus 16B₁ (projector 1) or whether the selection is to be cancelled.

When the display location of “Yes (Y)” is designated on the location screen 40B displayed on the display unit 26 in accordance with the user's operation instruction via the input unit 25, the control unit 20 determines that the execution instruction has been received from the input unit 25 so that a positive determination is made at Step S108 (Step S108: Yes). Conversely, when the display location of “No (N)” or “Cancel” is designated on the location screen 40B displayed on the display unit 26 in accordance with the user's operation instruction via the input unit 25, the control unit 20 makes a negative determination at Step S108 (Step S108: No), and the process returns to Step S106.

With reference back to FIG. 4, next, the control unit 20 determines whether access information has been acquired from the server device 12 (Step S112). The access information indicates the location where a program is stored, the program being used for controlling the second information processing apparatus 16B that is identified by the apparatus ID selected at the above-described Step S106. The access information is indicated by, for example, the Uniform Resource Locator (URL) that indicates the location where the program is stored within the server device 12.

The control unit 20 repeats a negative determination (Step S112: No) until a positive determination is made at Step S112 (Step S112: Yes). When a positive determination is made at Step S112 (Step S112: Yes), the process proceeds to Step S114.

The control unit 20 displays, on the display unit 26, the input screen that is acquired from the server device 12 (Step S114).

Specifically, when the access to the URL that is indicated by the access information acquired at the above-described Step S112 is designated in accordance with the user's operation instruction via the input unit 25, the control unit 20 refers to the location that is indicated by the access information. Thus, the server device 12 executes the program (the program for controlling the second information processing apparatus 16B) that is stored in the location indicated by the access information.

When the server device 12 executes the program, the first information processing apparatus 16A is provided with the input screen or the display screen for setting various types of instruction information that are included in the control signal. That is, when the execution unit 32C of the server device 12 executes the program, the transmitting unit 32E provides, to the first information processing apparatus 16A, various screens, such as the input screen or the display screen, which are displayed on the display unit 26 during the operation below.

For example, the first information processing apparatus 16A uses browser software, or the like, to access, via the network 14, the location that is indicated by the above-described access information and that is in the server device 12. The execution unit 32C then executes the program that is stored in the location indicated by the access information, i.e., the program for remotely controlling the second information processing apparatus 16B; thus, the first information processing apparatus 16A is capable of using, as a form of service, the function of the program for controlling the second information processing apparatus 16B (the information processing apparatus 16) managed by the server device 12.

FIG. 4 illustrates, as an example, a case where the control signal includes, as instruction information, the image data that is an object to be displayed in the second information processing apparatus 16B, the instruction to display an image on the image data, and the setting information at the time of displaying an image.

The control unit 20 first displays, as the input screen, the input screen for the setting information at the time of displaying an image (Step S114).

In the present embodiment, an explanation is given of a case where, after the control unit 20 displays the input screen for the setting information, the control unit 20 displays the input screen for the image data that is an object to be displayed in the second information processing apparatus 16B, as described below. That is, an explanation is given of a case where these input screens are sequentially provided by the server device 12.

However, when a positive determination is made at Step S112 (Step S112: Yes), the control unit 20 may selectably display, on the display unit 26, the textual information (e.g., “setting”) to prompt the display of the input screen for the setting information at the time of displaying an image or the textual information (e.g., “image data”) to prompt the display of the input screen for the image data that is an object to be displayed in the second information processing apparatus 16B. When the “setting” is selected in accordance with the user's operation instruction via the input unit 25, the signal for requesting the input screen for the setting information at the time of displaying an image is transmitted to the server device 12 and then the input screen is transmitted from the server device 12, whereby the operation may be performed at Step S114.

Furthermore, when the “image data” is selected in accordance with the user's operation instruction via the input unit 25, the signal for requesting the input screen for the image data that is an object to be displayed in the second information processing apparatus 16B is transmitted to the server device 12 and then the input screen is transmitted from the server device 12, whereby the process may be performed at Step S120, which will be described later.

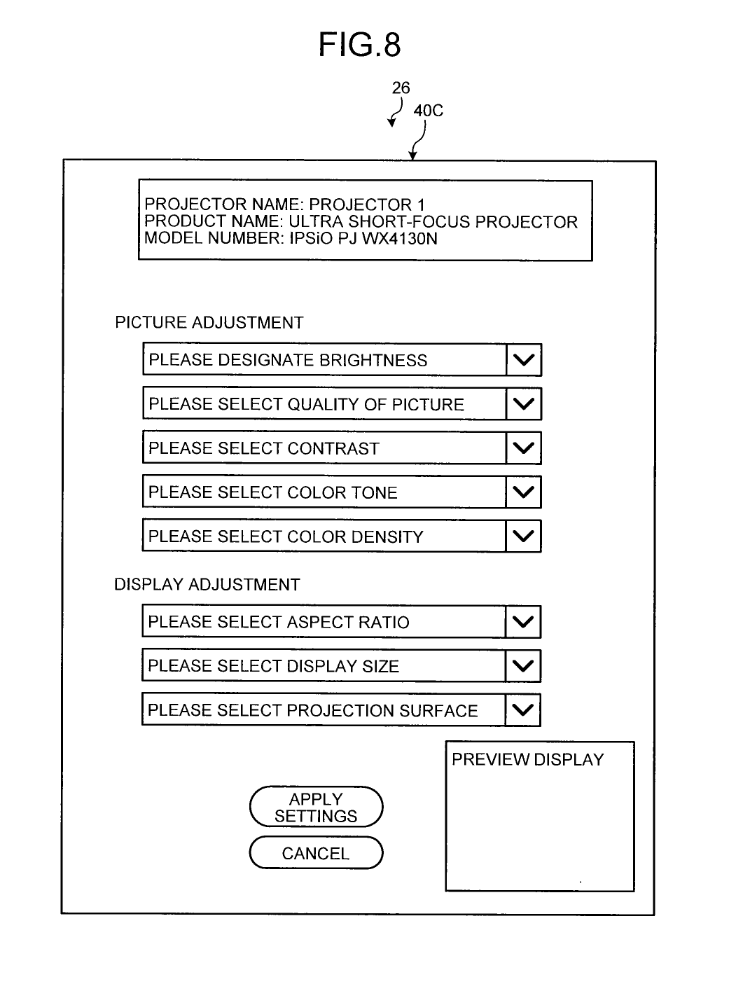

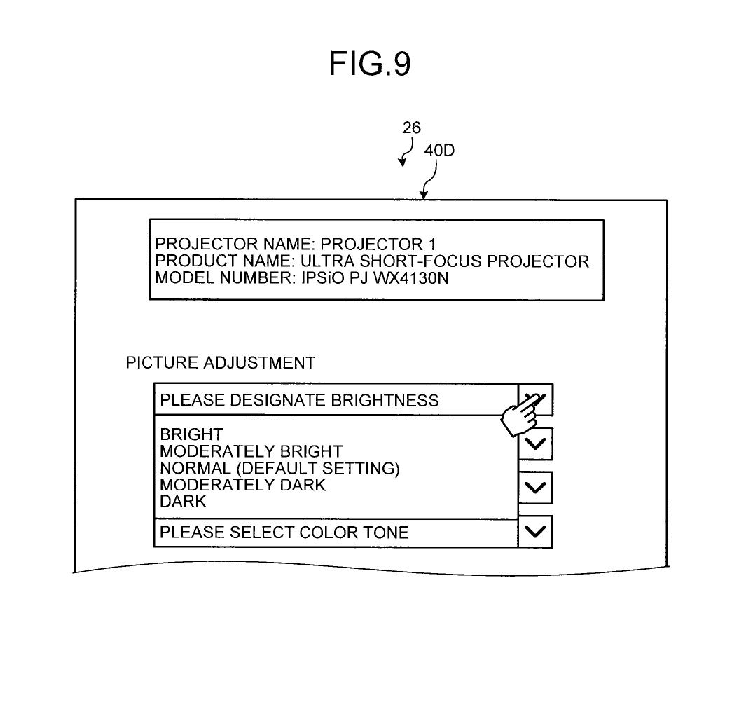

FIGS. 8 and 9 are schematic diagrams that illustrate examples of an input screen 40C and a setting screen 40D that are displayed on the display unit 26 during the operation at Step S114.

As illustrated in FIG. 8, the display unit 26 displays, for example, the input screen 40C for the setting information at the time of displaying an image in the selected second information processing apparatus 16B₁ (the projector 1). The input screen 40C displays, for example, the information for identifying the second information processing apparatus 16B1 (the projector 1) or displays the list of items to input one or more pieces of setting information at the time of displaying an image in the second information processing apparatus 16B1 (the projector 1). In the example illustrated in FIG. 8, the list of items to make picture adjustment and display adjustment is displayed.

For example, assume that the display location of “please select the brightness” for selecting the “brightness” on the input screen 40C is selected in accordance with the user's operation instruction via the input unit 25, the “brightness” being one of the items in the setting information. In this case, as illustrated in FIG. 9, the setting screen 40D is displayed on the display unit 26 for the setting of the “brightness” in detail. In the example illustrated in FIG. 9, the adjustment items of the “brightness” are displayed such that any one of the “bright”, “moderately bright”, “normal”, “moderately dark”, and “dark” is selectable. The user selects, through the operation instruction via the input unit 25, the brightness of the image to be displayed from the selected adjustment items so as to set the “brightness” of the image to be displayed.

Similarly, the user is able to desirably set each of the items in the setting information through the input screen 40C.

With reference back to FIG. 8, assume that, with respect to, for example, the quality of picture, the display location of the item “please select the quality of picture” for the quality of picture is selected in accordance with the user's operation instruction via the input unit 25. In this case, for example, the setting screen may be displayed for the setting of “the quality of picture” in detail such that “high brightness”, “standard”, and “natural” are selectably displayed. The “high brightness” indicates the picture mode in which it is easy to see a picture in the light. The “standard” indicates the standard picture mode. The “natural” indicates the picture mode in which photographs, or the like, look natural.

Furthermore, assume that, with respect to the contrast, the display location of the item “please select the contrast” for the contrast is selected in accordance with the user's operation instruction via the input unit 25. In this case, for example, the setting screen may be displayed for the setting of the “contrast” in detail such that the range between “−16” and “+16” is selectably displayed. The default value is, for example, “0”.

Furthermore, assume that, with respect to the color tone, the display location of the item “please select the color tone” for the color tone is selected in accordance with the user's operation instruction via the input unit 25. In this case, for example, the setting screen may be displayed for the setting of the “color tone” in detail such that the range between “−16” and “+16” is selectably displayed. The default value is, for example, “0”.

Moreover, assume that, with respect to the color density, the display location of the item “please select the color density” for the color density is selected in accordance with the user's operation instruction via the input unit 25. In this case, for example, the setting screen may be displayed for the setting of the “color density” in detail such that the range between “−16” and “+16” is selectably displayed. The default value is, for example, “0”.

Similarly, assume that, with respect to the aspect ratio of the display screen, the display location of the item “please select the aspect ratio” for the aspect ratio is selected in accordance with the user's operation instruction via the input unit 25. In this case, for example, the setting screen may be displayed to set the “aspect ratio” in detail such that “normal”, “16:9”, “full”, “real”, and “zoom” are selectably displayed.

The “normal” indicates the full-screen display without changing the aspect ratio of the input signal. The “16:9” indicates an aspect ratio of 16:9. It is, for example, 1280×720 dots. The “full” indicates, for example, 1280×800 dots. The “real” indicates that the resolution of the input signal is applied without any change. The “zoom” indicates that the width of the picture corresponds to the width of the projection screen while the aspect ratio of the input signal is maintained.

Moreover, assume that, with respect to the display size, the display location of the item “please select the display size” for the display size is selected in accordance with the user's operation instruction via the input unit 25. In this case, for example, the setting screen may be displayed for the setting of the “display size” in detail such that “projection screen, full”, “projection screen, medium”, and “projection screen, small” are selectably displayed. For example, the “projection screen, full” is set as default.

Furthermore, assume that, with respect to the projection surface, the display location of the item “please select the projection surface” for the projection surface is selected in accordance with the user's operation instruction via the input unit 25. In this case, for example, the setting screen may be displayed for the setting of the “projection surface” in detail such that “screen”, “white wall”, and “white board” are selectably displayed.

The “screen” is set as default. The “white wall” indicates that the sharpness is changed. The “white board” indicates that the sharpness is changed.

The display unit 26 of the first information processing apparatus 16A may display the preview screen that shows a state where an image is displayed in the second information processing apparatus 16B. The preview screen is not the actual screen that is projected onto the second information processing apparatus 16B. The preview screen may be generated by the server device 12 and be transmitted to the first information processing apparatus 16A. The first information processing apparatus 16A may display, on the display unit 26, the preview screen that is received from the server device 12. Furthermore, when the setting information is changed, the preview screen may be updated. Moreover, the preview screen may be displayed on the display unit 26 when the button for designating the display of the preview screen is displayed on the display unit 26 and then the area of the displayed button is designated in accordance with the user's operation instruction via the input unit 25.

When the user has completed the setting of the setting information, the user designates the display location of the button “apply the setting” illustrated in FIG. 8 in accordance with the operation instruction via the input unit 25. Thus, the control signal is output from the input unit 25 to the control unit 20, the control signal including, as instruction information, the setting information at the time of displaying an image and the instruction to apply the setting that are set through the input screen 40C and the setting screen 40D in FIGS. 8 and 9.

With reference back to FIG. 4, the control unit 20 determines whether the applying instruction has been received from the input unit 25 (Step S116). The control unit 20 repeatedly makes a negative determination (Step S116: No) until a positive determination is made at Step S116 (Step S116: Yes). When a positive determination is made at Step S116 (Step S116: Yes), the process proceeds to Step S118.

At Step S118, the control unit 20 transmits, to the server device 12, the setting information that is input in accordance with the user's operation instruction via the input unit 25 (Step S118). Specifically, the control unit 20 transmits, to the server device 12, the control signal that includes, as instruction information, the setting information at the time of displaying an image and the instruction to apply the setting that are input in accordance with the user's operation instruction via the input unit 25.

Next, the control unit 20 displays, on the display unit 26, the input screen for the image data that is an object to be displayed in the second information processing apparatus 16B (Step S120). As described above, the input screen is transmitted from the server device 12 when the server device 12 executes the program for controlling the second information processing apparatus 16B.

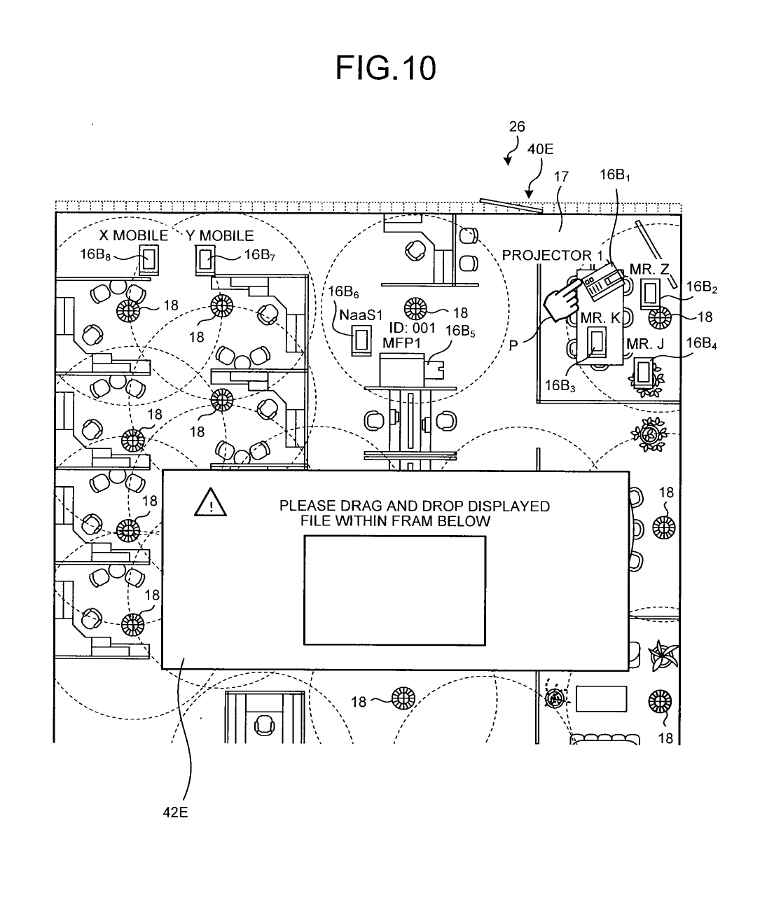

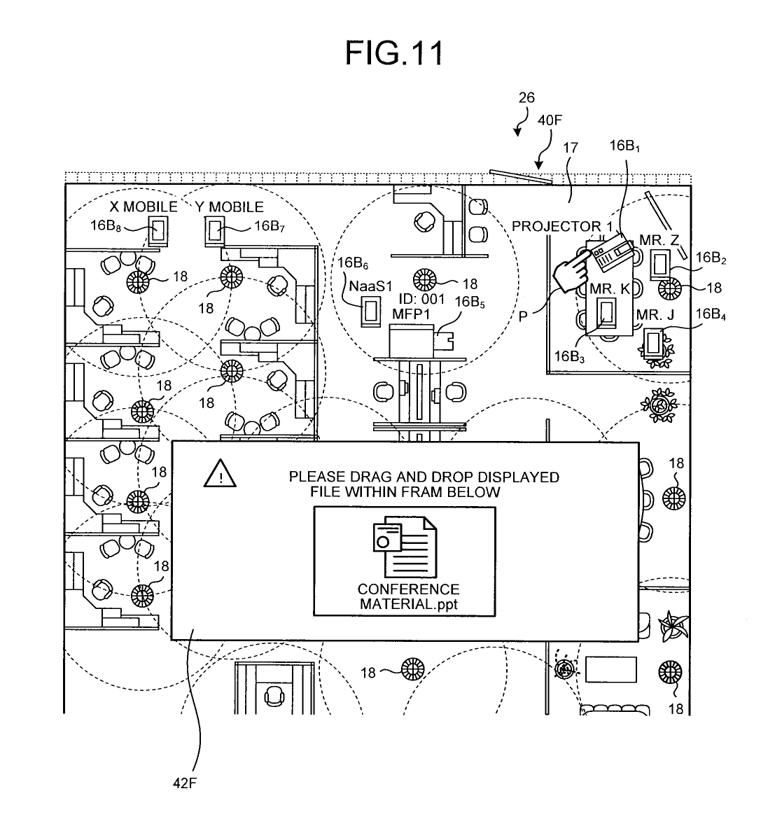

FIGS. 10 and 11 are schematic diagrams that illustrate examples of an input screen 40E and an input screen 40F that are displayed on the display unit 26 during the operation at Step S120.

As illustrated in FIG. 10, the display unit 26 displays the input screen 40E for the image data that is an object to be displayed in the second information processing apparatus 16B. For example, the Power Point image data with the file name “conference material”, which is the image data to be displayed, is dragged and dropped within a window 42E in accordance with the user's operation instruction via the input unit 25. At that time, the information (e.g., “please drag and drop the displayed file within the frame below”) for prompting the drag and drop may be displayed within the window 42E. Thus, a state is obtained such that the image data to be displayed in the second information processing apparatus 16B has been designated. FIG. 11 is a schematic diagram that illustrates a state where the Power Point image data with the file name “conference material” has been dragged and dropped within the window 42F.

With reference back to FIG. 4, the control unit 20 then determines whether the input unit 25 has designated the image data (Step S122). At Step S122, a negative determination is repeated (Step S122: No) until a positive determination is made (Step S122: Yes). If a positive determination is made at Step S122 (Step S122: Yes), the process proceeds to Step S124.

At Step S124, the image data designated at the above-described Step S122 is transmitted to the server device 12 (Step S124). For example, if the Power Point image data with the file name “conference material” is selected during the operation at the above-described Step S122, the control unit 20 transmits the image data to the server device 12. Specifically, at Step S124, the communication unit 28 transmits, to the server device 12, the control signal that includes, as instruction information, the image data that is an object to be displayed and the instruction to display the image on the image data.

Next, the control unit 20 determines whether the remote control on the second information processing apparatus 16B is to be terminated (Step S126). For example, the control unit 20 determines whether a predetermined button that indicates termination has been designated in accordance with the user's operation instruction via the input unit 25, thereby making a determination at Step S126.

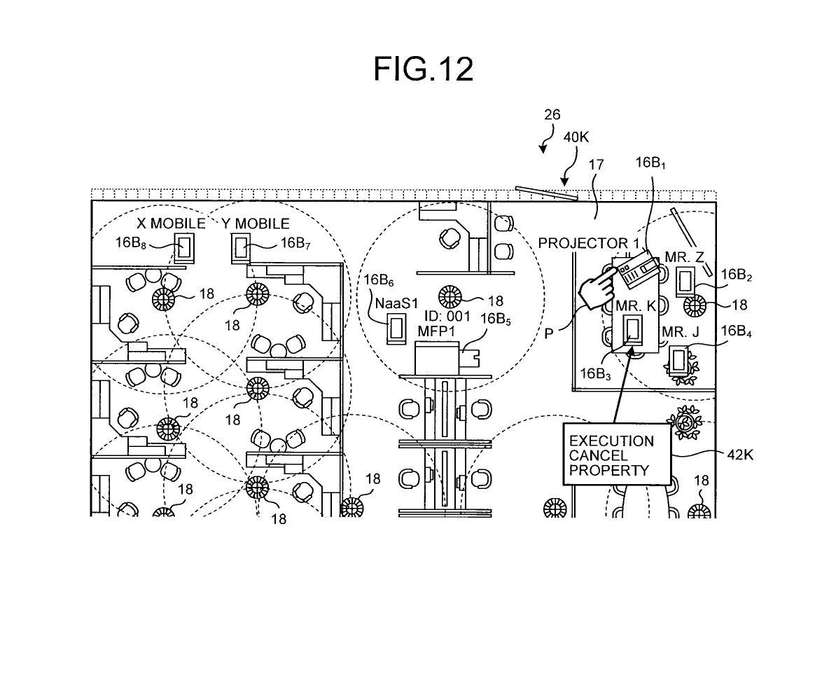

FIG. 12 is a schematic diagram that illustrates an example of a screen 40K that is displayed on the display unit 26 during the termination.

As illustrated in FIG. 12, for example, when a predetermined area is designated in accordance with the user's operation instruction via the input unit 25, the control unit 20 displays, on the display unit 26, a window 42K to select any of the execution, canceling, and property. When the display area of the “execution” is designated within the window 42K in accordance with the user's operation instruction via the input unit 25, the signal indicating termination may be transmitted from the input unit 25 to the control unit 20. The control unit 20 determines whether the signal indicating termination has been received so as to make a determination at Step S126. The screen 40K including the window 42K is transmitted from the server device 12 when the server device 12 executes the program for controlling the second information processing apparatus 16B.

With reference back to FIG. 4, if a negative determination is made at Step S126 (Step S126: No), the process returns to the above-described Step S114. Conversely, if a positive determination is made at Step S126 (Step S126: Yes), the process proceeds to Step S128.

At Step S128, the control unit 20 transmits, to the server device 12, the termination instruction that indicates the termination of the remote control on the second information processing apparatus 16B that is selected at the above-described Step S106 (Step S128), and the present routine is terminated.

When the second information processing apparatus 16B selected at Step S106 performs an operation in accordance with the control signal transmitted from the first information processing apparatus 16A, the server device 12 transmits, to the first information processing apparatus 16A, the execution status information that indicates the execution status of the operation performed by the second information processing apparatus 16B, due to the process performed by the server device 12, which will be described later.

For example, when the image data, which is designated by the first information processing apparatus 16A as an object to be displayed, is displayed in the second information processing apparatus 16B, the server device 12 transmits, to the first information processing apparatus 16A and as the execution status information, the signal indicating that the image data has been displayed in the second information processing apparatus 16B. The first information processing apparatus 16A displays, on the display unit 26, the information indicating that the image has been displayed. Thus, the first information processing apparatus 16A can provide the user with the operation that is being executed by the second information processing apparatus 16B, which is a remotely operated object, in real time.

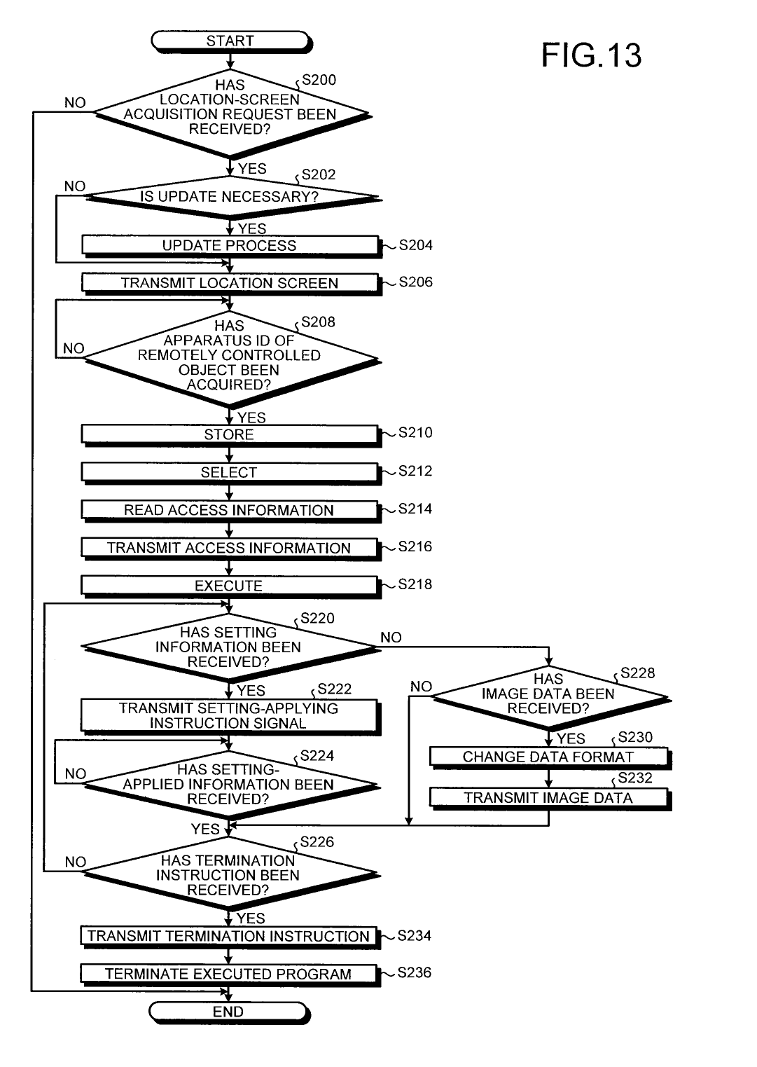

FIG. 13 is a flowchart that illustrates an example of the steps of the information processing performed by the server device 12.

First, the control unit 32 of the server device 12 determines whether the location-screen acquisition request has been received from the first information processing apparatus 16A (Step S200). When a negative determination is made at Step S200 (Step S200: No), the present routine is terminated. Conversely, when a positive determination is made at Step S200 (Step S200: Yes), the process proceeds to Step S202.

At Step S202, the control unit 32 determines whether the location screen needs to be updated (Step S202). For example, each time the location screen is generated or updated, the control unit 32 stores, in the storage unit 36, the time when the location screen is generated or the time when the location screen is updated. It is determined whether a predetermined time has elapsed from the time when the location screen is previously generated or the time when the location screen is previously updated, thereby making a determination at Step S202.

When a positive determination is made at Step S202, the process proceeds to Step S204. At Step S204, the generation unit 32F performs the process to update the location screen (Step S204).

Specifically, the generation unit 32F first acquires the apparatus IDs of all of the information processing apparatuses 16 that are connected to the server device 12 via the network 14. For example, the generation unit 32F acquires the apparatus IDs of the information processing apparatuses 16 from the power feeding devices 18 that feed the electric power to the information processing apparatuses 16.

Specifically, the generation unit 32F transmits the retrieval request to each of the power feeding devices 18 that are connected to the network 14. The generation unit 32F then acquires, from each of the power feeding devices 18 and as the retrieval result in response to the retrieval request, the power feeding ID of the power feeding device 18, the positional information on the power feeding device 18, the apparatus ID of the information processing apparatus 16 to which the power feeding device 18 feeds the electric power, and the time in which the electric power is fed to the information processing apparatus 16 that is identified by the apparatus ID. The generation unit 32F then stores, in the storage unit 36, the positional information and the power feeding time that are indicated by the acquired retrieval result and are related to each of the apparatus IDs. Furthermore, the generation unit 32F registers the positional information, which is indicated by the acquired retrieval result and is related to each of the apparatus IDs, as the latest positional information on each of the apparatus IDs, thereby updating the second data.

Next, the generation unit 32F reads, from the storage unit 36, the information about the information processing apparatus 16 that is related to the apparatus ID of the information processing apparatus 16 connected to the server device 12 via the network 14 and is identified by the apparatus ID and reads the first image that is related to the information processing apparatus 16 identified by the apparatus ID. The information about the information processing apparatus 16 is, for example, the apparatus identification information, the positional information, the operation status, the power feeding time, the power feeding ID, or the like.

The generation unit 32F then generates the location screen in which the first image of each of the information processing apparatuses 16 is located at a position on the prepared map information or layout, the position corresponding to the positional information on each of the information processing apparatuses 16. The generated location screen is stored in the storage unit 36 such that it is related to the generation time. Thus, the generation unit 32F generates or updates the location screen.

The generation unit 32F may directly acquire the apparatus ID from each of the information processing apparatuses 16 instead of acquiring it from the power feeding device 18. Moreover, the generation unit 32F may acquire the fourth data from the power feeding device 18 so as to acquire the apparatus ID.

Next, at Step S206, the transmitting unit 32E transmits the location screen to the first information processing apparatus 16A that has transmitted the location-screen acquisition request acquired at the above-described Step S200 (Step S206).

The acquisition unit 32A then determines whether the apparatus ID of the second information processing apparatus 16B, which is a remotely controlled object, has been acquired from the first information processing apparatus 16A (Step S208). At Step S208, a negative determination is repeated (Step S208: No) until a positive determination is made (Step S208: Yes).

When a positive determination is made at Step S208 (Step S208: Yes), the process proceeds to Step S210.

At Step S210, the apparatus ID acquired at Step S208 is stored in the storage unit 36 as connection destination information such that it is related to the apparatus ID of the first information processing apparatus 16A that has transmitted the location-screen acquisition request at the above-described Step S200 (Step S210). Thus, the second data is updated.

The selection unit 32B then selects, from the storage unit 36, the program that is related to the apparatus ID received at Step S208 (Step S212). Specifically, the selection unit 32B reads, from the first data in the storage unit 36, the program that is related to the apparatus ID received at Step S208, thereby selecting the related program.

Next, the selection unit 32B reads the location where the program selected at Step S212 is stored, thereby reading the access information (Step S214). The transmitting unit 32E transmits the access information read at Step S214 to the first information processing apparatus 16A that has transmitted the location-screen acquisition request at the above-described Step S200 (Step S216).

Next, when the first information processing apparatus 16A accesses the program indicated by the access information, the execution unit 32C executes the program that is identified by the access information, i.e., the program that is selected by the selection unit 32B at the above-described Step S212 (Step S218).

As the program is executed during the operation at Step S218, the server device 12 enters a state where the server device 12 is capable of receiving a control signal from the first information processing apparatus 16A and is capable of causing the corresponding second information processing apparatus 16B to perform the process that corresponds to the received control signal. Furthermore, the server device 12 enters a state where the server device 12 is capable of providing the first information processing apparatus 16A with various screens, such as the above-described input screen or the display screen. Moreover, the server device 12 enters a state where the server device 12 is capable of receiving the execution status information from the second information processing apparatus 16B and is capable of transmitting it to the first information processing apparatus 16A.

Next, the receiving unit 32D determines whether the receiving unit 32D has received the setting information from the first information processing apparatus 16A (Step S220). Specifically, at Step S220, the receiving unit 32D determines whether the receiving unit 32D has received, from the first information processing apparatus 16A, the control signal that includes, as instruction information, the setting information at the time of displaying an image and the instruction to apply the setting.

When a positive determination is made at Step S220, the transmitting unit 32E transmits, to the second information processing apparatus 16B that has the apparatus ID acquired at the above-described Step S208, the control signal received at the above-described Step S220 as setting-applying instruction signal, the control signal including, as instruction information, the setting information at the time of displaying an image and the instruction to apply the setting (Step S222). The transmitting unit 32E forwards the control signal as the setting-applying instruction signal to the second information processing apparatus 16B on the basis of, for example, the HTTP protocol, the control signal including, as instruction information, the setting information at the time of displaying an image and the instruction to apply the setting.

Next, the receiving unit 32D determines whether the receiving unit 32D has received, from the second information processing apparatus 16B to which the setting-applying instruction signal has been transmitted at the above-described Step S222, the information indicating that the setting has been applied as the execution status information (Step S224). The receiving unit 32D repeats a negative determination (Step S224: No) until a positive determination is made at Step S224 (Step S224: Yes). When a positive determination is made at Step S224 (Step S224: Yes), the process proceeds to Step S226.

At Step S226, the receiving unit 32D determines whether the receiving unit 32D has received the termination instruction from the first information processing apparatus 16A (Step S226). When a negative determination is made at Step S226 (Step S226: No), the process returns to the above-described Step S220. Conversely, when a positive determination is made at Step S226 (Step S226: Yes), the process proceeds to Step S234.

At Step S234, the termination instruction is transmitted to the second information processing apparatus 16B that is identified by the apparatus ID received at the above-described Step S208 (Step S234). Next, the execution unit 32C terminates the program that has been executed at the above-described Step S218 (Step S236), and the present routine is terminated.

When a positive determination is made at the above-described Step S224 (Step S224: Yes), the information indicating that the setting has been applied may be transmitted to the first information processing apparatus 16A as the execution status information. In this case, when receiving the information indicating that the setting has been applied as the execution status information, the first information processing apparatus 16A may display, on the display unit 26, the image indicating that the setting has been applied. For example, the control unit 20 of the first information processing apparatus 16A may display the pop-up screen on the display unit 26 and display, within the pop-up screen, the information indicating that the setting has been applied. Thus, the first information processing apparatus 16A is capable of displaying, on the display unit 26, that the details of the setting designated with respect to the second information processing apparatus 16B, which is a remotely controlled object, have been applied to the second information processing apparatus 16B.

Conversely, when a negative determination is made at the above-described Step S220 (Step S220: No), the process proceeds to Step S228. At Step S228, the receiving unit 32D determines whether the receiving unit 32D has received the image data from the first information processing apparatus 16A (Step S228). Specifically, at Step S228, the receiving unit 32D determines whether the receiving unit 32D has received, from the first information processing apparatus 16A, the control signal that includes, as instruction information, the image data that is an object to be displayed and the instruction to display the image on the image data.

When a positive determination is made at Step S228 (Step S228: Yes), the process proceeds to Step S230. At Step S230, the control unit 32 changes the image data included in the received control signal into a data format that can be processed by the second information processing apparatus 16B that is identified by the apparatus ID acquired at the above-described Step S208 (Step S230).

The server device 12 may preliminarily store, in the storage unit 36, the data format that can be processed by using the second information processing apparatus, the data format being related to the apparatus ID. The control unit 32 of the server device 12 may read, from the storage unit 36, the data format that is related to the apparatus ID acquired at Step S208 and change the image data acquired from the first information processing apparatus 16A into the read data format.

Next, the transmitting unit 32E transmits the image data whose data format has been changed at Step S230 to the second information processing apparatus 16B that is identified by the apparatus ID received at the above-described Step S208 (Step S232). Specifically, at Step S232, the transmitting unit 32E transmits, to the second information processing apparatus 16B, the control signal that includes, as instruction information, the image data whose data format has been changed at Step S230 and the instruction to display the image on the image data. The process then proceeds to Step S226.

For example, the program that is capable of executing data with various data formats is installed in the control unit 32 of the server device 12. The control unit 32 opens the image data whose data format has been changed. The transmitting unit 32E uses a utility tool that is pre-installed in the control unit 32 and corresponds to each of the apparatus IDs to capture the image on the image data in certain intervals, e.g., in each page of the image and then sequentially transmits it to the second information processing apparatus 16B.

After the image data is transmitted to the second information processing apparatus 16B at the above-described Step S232, the signal indicating that the image has been displayed or the details (e.g., the file name, or the page information) of the displayed image may be received as the execution status information from the second information processing apparatus 16B. In this case, when the receiving unit 32D receives, as the execution status information, the signal indicating that the image has been displayed from the second information processing apparatus 16B, the transmitting unit 32E transmits, to the first information processing apparatus 16A, the signal indicating that the image on the designated image data has been displayed as the execution status information. When receiving the execution status information, the control unit 20 of the first information processing apparatus 16A may display the pop-up screen on the display unit 26 and display, within the pop-up screen, the name of the image data displayed in the second information processing apparatus 16B and the information indicating that the image has been displayed in the second information processing apparatus 16B.

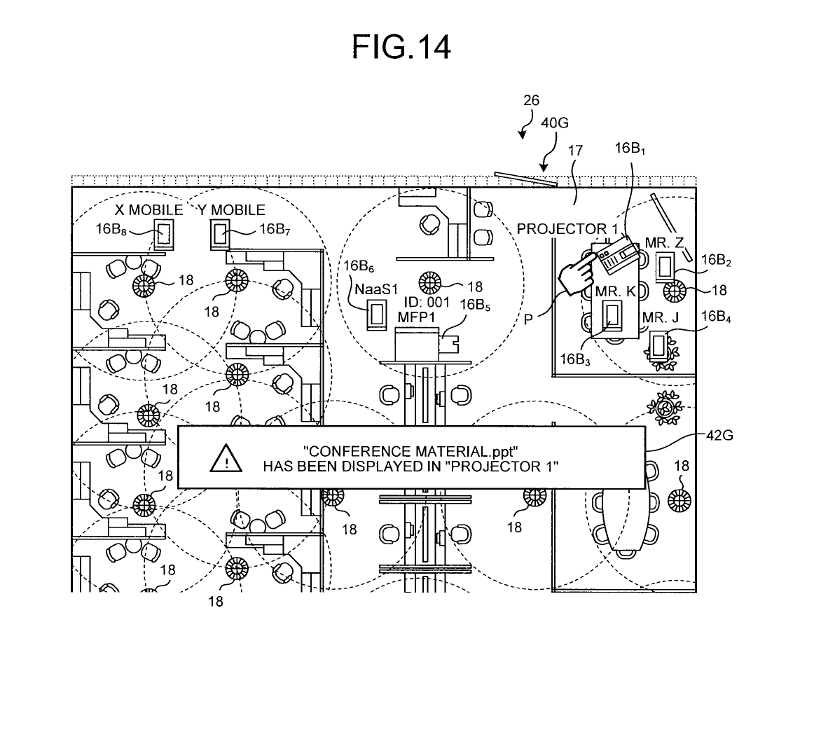

FIG. 14 is a schematic diagram that illustrates a state where a pop-up screen 42G is displayed on the display unit 26. As illustrated in FIG. 14, the control unit 20 displays, on a display screen 40G of the display unit 26, the pop-up screen 42G that includes the name of the image data and the information indicating that the image has been displayed in the second information processing apparatus 16B. Thus, the user is able to understand the remotely controlled state of the second information processing apparatus 16B. The display screen 40G and the pop-up screen 42G may be transmitted as the execution status information from the server device 12 to the first information processing apparatus 16A.

With reference back to FIG. 13, when a negative determination is made at the above-described Step S228 (Step S228: No), the process proceeds to the above-described Step S226.

If a negative determination is made at Step S228 (Step S228: No), i.e., if the information received from the first information processing apparatus 16A is a control signal other than the control signal that includes, as instruction information, the setting information at the time of displaying an image and the instruction to apply the setting or other than the control signal that includes, as instruction information, the image data and the instruction to display the image on the image data, the operation identified by the instruction information included in the received control signal may be performed. For example, if the control signal from the first information processing apparatus 16A includes the instruction information that indicates turning over the page, the control unit 32 of the server device 12 may transmit, to the first information processing apparatus 16A, the page image of the page next to the page of the image displayed in the second information processing apparatus 16B and may transmit, to the second information processing apparatus 16B, the control signal that includes the instruction information that indicates turning over the page of the displayed image.

Here, it is desirable to transmit the image data from the server device 12 to the second information processing apparatus 16B by using a known motion picture compression technique, such as Motion Jpeg. In this case, when receiving the compressed image data, the second information processing apparatus 16B may decompress the image data and then display it. Thus, it is possible to reduce the loads on the network 14.

Here, an explanation is given of a case where the first information processing apparatus 16A designates “conference material.ppt” as the image data to be displayed in the second information processing apparatus 16B.

The “conference material.ppt” is the image data that has the name “conference material” and that is generated by using Power Point.

Virtual Network Computing (VNC) has been known as the technology for remotely controlling the second information processing apparatus 16B that is connected to the network 14. In this technology, however, dedicated software needs to be installed in not only the server device 12 but also each of the information processing apparatuses 16.

Meanwhile, in the present embodiment, the program is executed by only the server device 12 so that the second information processing apparatus 16B can be remotely controlled by the first information processing apparatus 16A.

For example, when the image data transmitted from the first information processing apparatus 16A to the server device 12 is designated by the first information processing apparatus 16A as the image data to be displayed in the second information processing apparatus 16B, the server device 12 opens the image data.

First, the server device 12 transmits, to the first information processing apparatus 16A, the pop-up screen for the list information that indicates the list of image data that is transmitted from the first information processing apparatus 16A to the server device 12 as objects to be displayed. Thus, the first information processing apparatus 16A is capable of displaying the pop-up screen on the display unit 26 of the first information processing apparatus 16A. The first information processing apparatus 16A accesses, via the network 14, the location that is indicated by the above-described access information and that is in the server device 12 by using browser software, or the like, so as to use the function of the program executed by the server device 12 as a form of service, whereby the screen is displayed on the display unit 26.

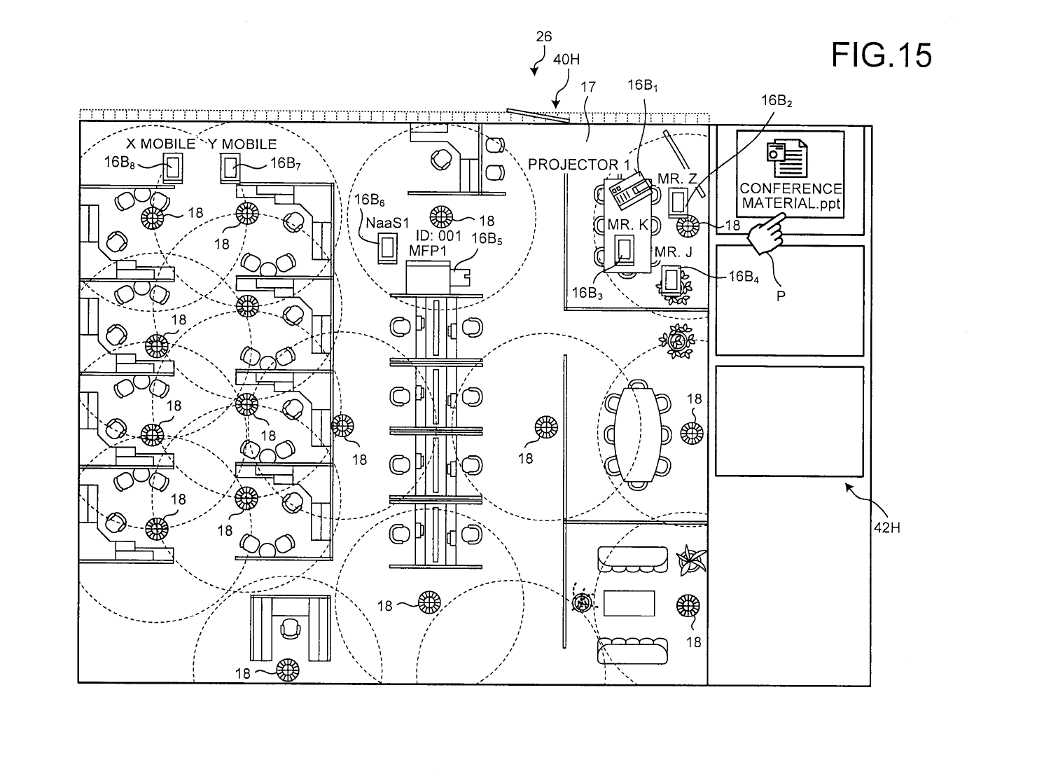

FIG. 15 is a schematic diagram that illustrates a state where a pop-up screen 42H is displayed on the display unit 26. Specifically, as illustrated in FIG. 15, the list information that indicates the list of image data that is transmitted to the server device 12 is displayed on the pop-up screen 42H of a display screen 40H in the display unit 26 of the first information processing apparatus 16A. If, for example, “conference material.ppt” is selected in accordance with the operation instruction via the input unit 25 in the first information processing apparatus 16A, the information indicating that the “conference material.ppt” has been selected is transmitted from the first information processing apparatus 16A to the server device 12.

When receiving the information, the server device 12 opens the “conference material.ppt”, which is the image data identified by the information, and transmits, to the first information processing apparatus 16A, the page image data on the image of the first page. Thus, the first information processing apparatus 16A displays the first page of the “conference material.ppt” on the display unit 26. Furthermore, the server device 12 transmits, to the second information processing apparatus 16B, the page image data on the first page of the “conference material.ppt” so that the display unit 26 of the second information processing apparatus 16B displays the first page of the “conference material.ppt”.

Furthermore, assume that the control signal including the instruction information for turning over the page of the displayed image so as to display the next page is transmitted to the server device 12 in accordance with the user's operation instruction via the input unit 25 in the first information processing apparatus 16A. When receiving the control signal that includes the instruction information for turning over the page, the server device 12 transmits, to the first information processing apparatus 16A, the page image data on the page next to the first page of the “conference material.ppt” and also transmits, to the second information processing apparatus 16B, the control signal that includes the instruction information for turning over the page. Instead of the control signal that includes the instruction information for turning over the page, the server device 12 may transmit, to the second information processing apparatus 16B, the control signal that includes, as the instruction information, the page image data obtained after the page is turned over (in this example, the page image data on the page next to the first page).

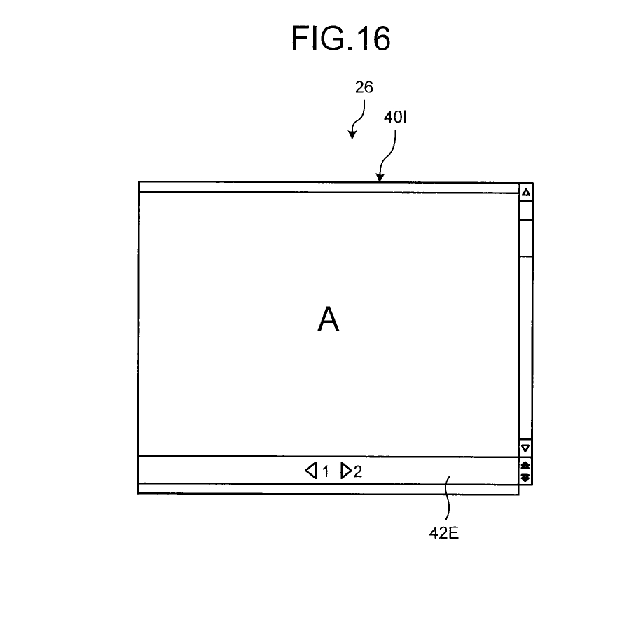

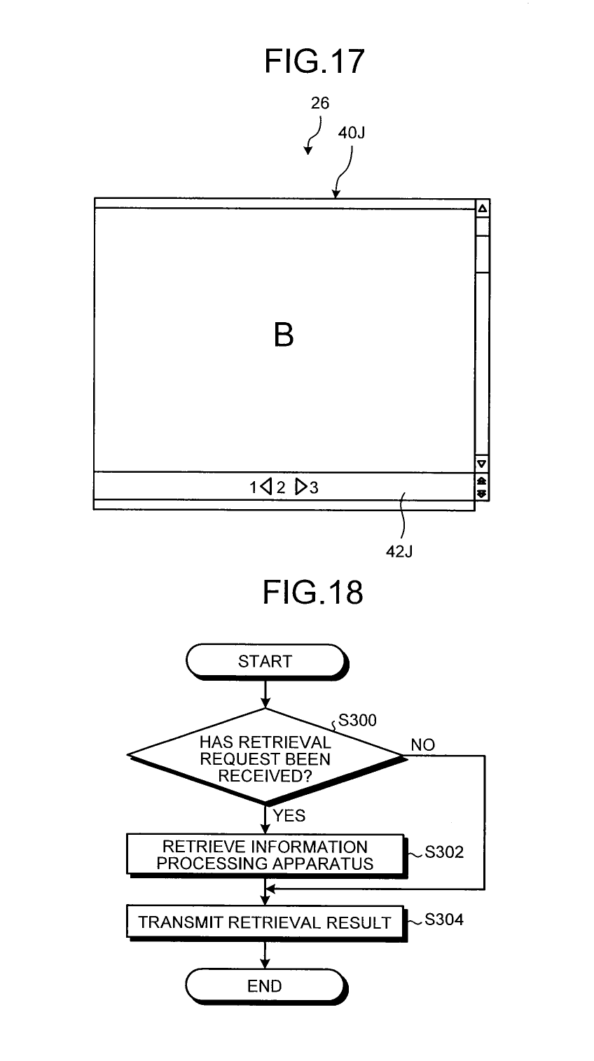

FIGS. 16 and 17 are schematic diagrams that illustrate examples of the image displayed on display screen 40I and 40J of the display unit 26.

For example, the server device 12 transmits, to the first information processing apparatus 16A, the page image data on the first page of the “conference material.ppt” and transmits the display screen of the pop-up window that includes the button image for giving an instruction to turn over the page and the button image for giving an instruction to turn back the page. Thus, as illustrated in FIG. 16, the display unit 26 of the first information processing apparatus 16A displays the pop-up window 42E as well as the page image of the first page of the “conference material.ppt”.

When the display location, in the pop-up window 42E, of the button image for giving an instruction to turn over the page is designated in accordance with the user's operation instruction via the input unit 25 in the first information processing apparatus 16A, the first information processing apparatus 16A transmits, to the server device 12, the control signal that includes the instruction information for turning over the page.

When receiving the control signal that includes the instruction information for turning over the page, the server device 12 transmits, to the first information processing apparatus 16A, the page image data on the page next to the first page and also transmits, to the first information processing apparatus 16A, the display screen of the pop-up window that includes the button image for giving an instruction to turn over the page and the button image for giving an instruction to turn back the page. Thus, as illustrated in FIG. 17, the display unit 26 of the first information processing apparatus 16A displays a pop-up window 42J as well as the page image of the page next to the first page of the “conference material.ppt”.

Thus, according to the present embodiment, the image data on all the pages is not transmitted from the server device 12 to the first information processing apparatus 16A, or a scrolling operation, or the like, is not performed by the first information processing apparatus 16A. Only the page image data to be displayed and the control signal including the instruction information for turning over the page, or the like, are received and transmitted between the first information processing apparatus 16A and the server device 12.

Therefore, the operation performed by the input unit 25 of the first information processing apparatus 16A to turn over the page, turn back the page, or the like, is applied to the server device 12 in real time, and the operation is also applied to the second information processing apparatus 16B in real time. Furthermore, the page displayed in the second information processing apparatus 16B can be checked by the first information processing apparatus 16A.

The above operation is applicable to the control signal that includes the instruction information not only for turning over or turning back the page but also for setting the enlargement percentage, setting the display screen, or the like.

Next, an explanation is given of the process performed by the power feeding device 18.

FIG. 18 is a flowchart that illustrates the steps of the retrieval process performed by the power feeding device 18.

The control unit 18B of the power feeding device 18 performs the process routine illustrated in FIG. 18 at predetermined time intervals. First, the control unit 18B determines whether a retrieval request has been received from the server device 12 (Step S300). When a negative determination is made at Step S300 (Step S300: No), the present routine is terminated. Conversely, when a positive determination is made at Step S300 (Step S300: Yes), the process proceeds to Step S302.

At Step S302, the control unit 18B retrieves the information processing apparatus 16 that is connected to the power feeding device 18 (Step S302).

Next, in accordance with the result of the retrieval at Step S302, the control unit 18B transmits, to the server device 12, the retrieval result that includes the power feeding ID of the power feeding device 18, the positional information on the power feeding device 18, the apparatus ID of the information processing apparatus 16 to which the power feeding devices 18 feeds the electric power, and the time in which the electric power is fed to the information processing apparatus 16 identified by the apparatus ID (Step S304). The present routine is then terminated.

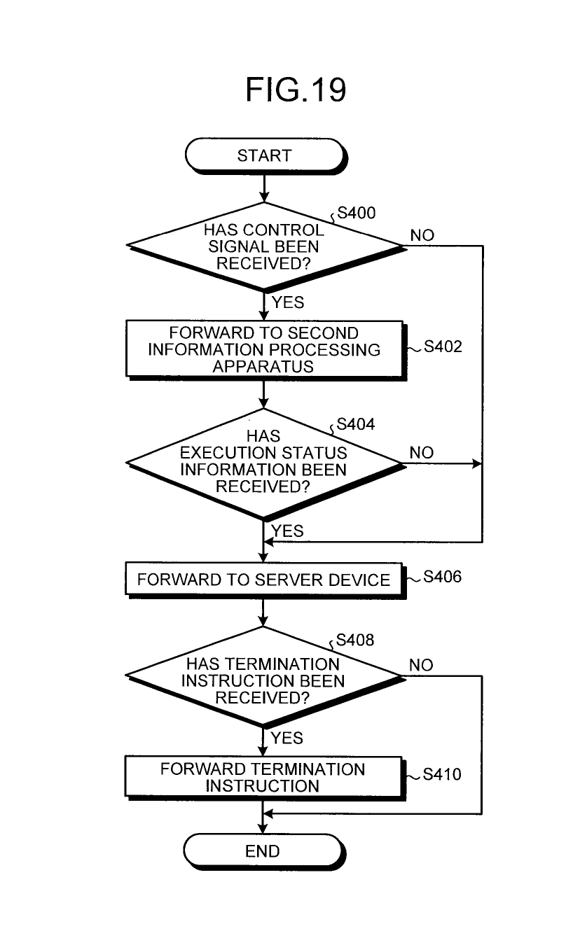

FIG. 19 is a flowchart that illustrates the steps of the information processing performed by the power feeding device 18.

First, the communication unit 18C determines whether a control signal has been received from the server device 12 (Step S400). When a negative determination is made at Step S400 (Step S400: No), the process proceeds to Step S408, which will be described later. Conversely, when a positive determination is made at Step S400 (Step S400: Yes), the process proceeds to Step S402.

At Step S402, the communication unit 18C forwards the control signal received at the above-described Step S400 to the second information processing apparatus 16B that is connected to the power feeding device 18 (Step S402). If the power feeding device 18 is connected to the multiple information processing apparatuses 16, the control signal may include the apparatus ID of the second information processing apparatus 16B that is the transmission destination. Among the connected information processing apparatuses 16 (the second information processing apparatuses 16B), the power feeding device 18 may transmit the control signal to the second information processing apparatus 16B that is identified by the apparatus ID included in the control signal.

Next, the communication unit 18C determines whether the execution status information has been received from the second information processing apparatus 16B (Step S404).

When a negative determination is made at Step S404 (Step S404: No), the process proceeds to Step S408, which will be described later. Conversely, when a positive determination is made at Step S404 (Step S404: Yes), the process proceeds to Step S406.

At Step S406, the communication unit 18C forwards, to the server device 12, the execution status information received at Step S404 (Step S406).

Next, the control unit 18B determines whether the termination instruction has been received from the server device 12 (Step S408). When a negative determination is made at Step S408 (Step S408: No), the present routine is terminated. Conversely, when a positive determination is made at Step S408 (Step S408: Yes), the process proceeds to Step S410.

At Step S410, the control unit 18B forwards the received termination instruction to the connected second information processing apparatus 16B (Step S410). The present routine is then terminated.

Next, an explanation is given of the information processing performed by the second information processing apparatus 16B.

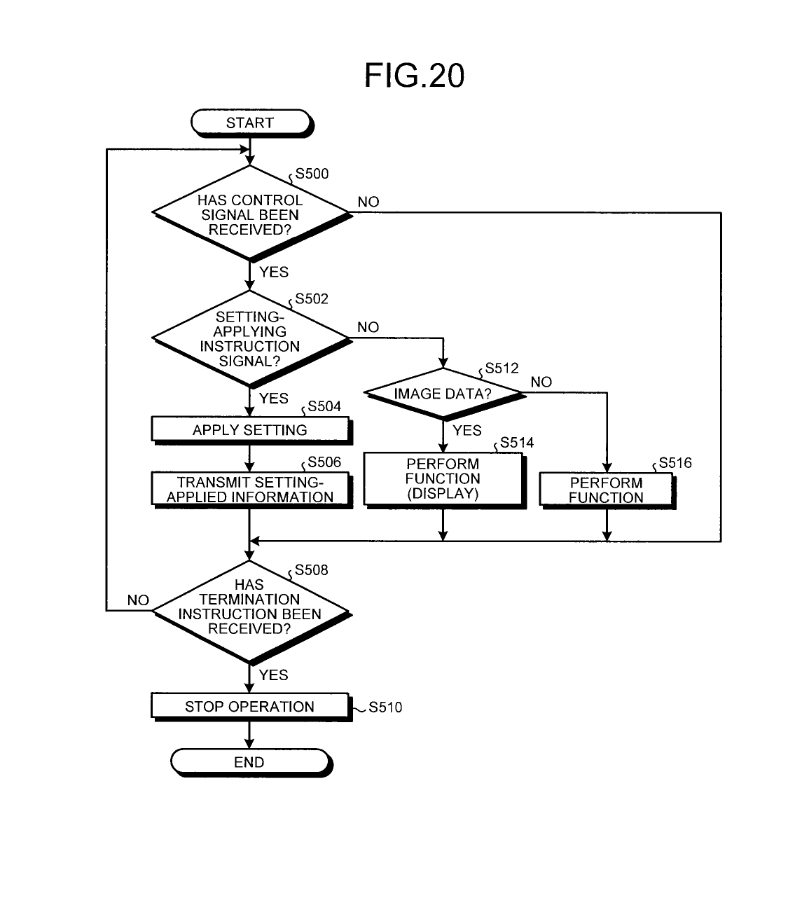

FIG. 20 is a flowchart that illustrates the steps of the information processing performed by the second information processing apparatus 16B.

First, the communication unit 28 determines whether a control signal has been received from the server device 12 (Step S500). When a negative determination is made at Step S500 (Step S500: No), the process proceeds to Step S508, which will be explained later. Conversely, when a positive determination is made at Step S500 (Step S500: Yes), the process proceeds to Step S502.

At Step S502, the control unit 20 determines whether the control signal received at the above-described Step S500 is the setting-applying instruction signal (Step S502). The control unit 20 determines whether the control signal received at the above-described Step S500 is the control signal that includes, as instruction information, the setting information at the time of displaying an image and the instruction to apply the setting, thereby making a determination at Step S502.

When a positive determination is made at Step S502 (Step S502: Yes), the process proceeds to Step S504.

Next, the control unit 20 stores, as the setting information for executing the function in the second information processing apparatus 16B, the setting information (i.e., the setting information at the time of displaying an image that is included in the control signal) that is indicated by the setting-applying instruction signal received at Step S502. Thus, the control unit 20 applies the setting (Step S504).

By the operation at Step S504, the control unit 20 of the second information processing apparatus 16B enters a state where the control unit 20 is capable of driving the drive unit 24 in accordance with the setting condition that corresponds to the setting information applied at Step S504. In the example of FIG. 20, it is assumed that the second information processing apparatus 16B is a projector. Specifically, the control unit 20 of the second information processing apparatus 16B enters a state where the control unit 20 can display an image on the display unit 26 in accordance with the display condition that corresponds to the setting information.

Next, the control unit 20 transmits, to the server device 12 and as the execution status information, the setting-applied information indicating that the setting has been applied (Step S506).

The communication unit 28 then determines whether the termination instruction has been received from the server device 12 (Step S508). When a negative determination is made at Step S508 (Step S508: No), the process returns to the above-described Step S500. Conversely, when a positive determination is made at Step S508 (Step S508: Yes), the process proceeds to Step S510.

At Step S510, the communication unit 28 stops the operation of the drive unit 24 (Step S510). The present routine is then terminated.

Conversely, when a negative determination is made at the above-described Step S502 (Step S502: No), the process proceeds to Step S512. At Step S512, the communication unit 28 determines whether the received control signal is the image data (Step S512). Specifically, at Step S512, the communication unit 28 of the second information processing apparatus 16B determines whether the received control signal is the control signal that includes, as instruction information, the image data that is an object to be displayed and the instruction to display the image on the image data.

When a positive determination is made at Step S512 (Step S512: Yes), the process proceeds to Step S514.

At Step S514, the image data received at Step S512 is displayed on the display unit 26 so that the function of the second information processing apparatus 16B is performed (Step S514). The process proceeds to the above-described Step S508. After the operation is performed at Step S514, the control unit 20 of the second information processing apparatus 16B may transmit, to the server device 12 and as the execution status information, the signal indicating that the image has been displayed.

Conversely, when a negative determination is made at the above-described Step S512 (Step S512: No), the process proceeds to Step S516. At Step S516, the control unit 20 controls the display unit 26 or the drive unit 24 so as to perform the function that is identified by the instruction information included in the control signal received at Step S500 (Step S516). The process proceeds to Step S508.

When the power of the second information processing apparatus 16B, which is an object remotely controlled by the first information processing apparatus 16A, is off, the process may be performed to turn on the power of the second information processing apparatus 16B.

In this case, the server device 12 may perform the following process.

For example, the control unit 32 of the server device 12 uses the power feeding time that is included in the retrieval result received from the power feeding device 18 to determine whether the electric power is being fed to each of the information processing apparatuses 16 (i.e., the power of each of the information processing apparatuses 16 is on) that are identified by the apparatus IDs included in the retrieval result.

If the power of the second information processing apparatus 16B, which is identified by the apparatus ID designated as a remotely controlled object by the first information processing apparatus 16A, is off, the control unit 32 may transmit the information for prompting the power-on of the second information processing apparatus 16B and the instruction to display the information to at least one of the information processing apparatuses 16 located near the second information processing apparatus 16B on the basis of the positional information on the second information processing apparatus 16B. When receiving, from the server device 12, the information for prompting the power-on of the second information processing apparatus 16B and the instruction to display the information, each of the information processing apparatuses 16 may display, on the display unit 26, the information for prompting the power-on of the second information processing apparatus 16B and the instruction to display the information.

Thus, the information for prompting the power-on of the second information processing apparatus 16B, which is a remotely controlled object of the first information processing apparatus 16A, can be displayed in the information processing apparatus 16 located near the second information processing apparatus 16B, and the information for prompting the power-on can be easily provided to the user.

As described above, in the server device 12 according to the present embodiment, when the acquisition unit 32A acquires the apparatus ID of the second information processing apparatus 16B, which is a remotely controlled object, from the first information processing apparatus 16A, the execution unit 32C executes the program so as to remotely control the second information processing apparatus 16B that is identified by the apparatus ID. The execution unit 32C executes the program so that it is loaded onto the main storage device and, as the functional unit generated on the main storage device, the receiving unit 32D and the transmitting unit 32E are generated on the main storage device. The receiving unit 32D receives the control signal for the second information processing apparatus 16B from the first information processing apparatus 16A, and the transmitting unit 32E transmits the control signal to the second information processing apparatus 16B.

Thus, with the server device 12 according to the present embodiment, it is possible to, by using one information processing apparatus 16 (the first information processing apparatus 16A), remotely control another information processing apparatus 16 (the second information processing apparatus 16B), which is an object to be controlled, in an easy and simple operation.

In the present embodiment, an explanation is given of a case where the information processing system 10 includes the power feeding device 18; however, the configuration may be such that there is no power feeding device 18. In this case, each of the information processing apparatuses 16 may be connected to the server device 12 via the network 14. Furthermore, the server device 12 may receive the positional information from each of the information processing apparatuses 16 instead of receiving the positional information from the power feeding device 18. Moreover, when the information processing apparatus 16 receives the positional-information acquisition request from the server device 12, the information processing apparatus 16 may transmit the identification information, the positional information, and the power feeding information on the information processing apparatus 16 to the server device 12.

In the present embodiment, a detailed explanation is given of a case where the first information processing apparatus 16A is a PC and the second information processing apparatus 16B is a projector. However, as described above, the first information processing apparatus 16A and the second information processing apparatus 16B are not limited to the PC and the projector.

For example, each of the first information processing apparatus 16A and the second information processing apparatus 16B may be a PC. In this case, assume that the first information processing apparatus 16A is located in the home, or the like, and the second information processing apparatus 16B is located in the office, or the like. The second information processing apparatus 16B that is installed in the office can be remotely controlled by the first information processing apparatus 16A that is installed in the home; thus, the user who is present in the home is able to use the PC as if the user is in the office.

Furthermore, the information that indicates the operation status of the second information processing apparatus 16B may be transmitted from the server device 12 to the first information processing apparatus 16A. In this case, the control unit 32 of the server device 12 reads, from the second data stored in the storage unit 36, the connection destination information that is related to the apparatus ID of the second information processing apparatus 16B, which is an object remotely controlled by the first information processing apparatus 16A. The control unit 32 of the server device 12 then reads, from the second data, the information that indicates the operation status that is related to the apparatus ID identified by the connection destination information and then transmits it to the first information processing apparatus 16A.

When receiving the information that indicates the operation status, the first information processing apparatus 16A displays, on the display unit 26, the information that indicates the operation status. Therefore, the first information processing apparatus 16A can provide a user with the operation status of the second information processing apparatus 16B, which is a remotely controlled object. Thus, the user is able to understand the operation status of the second information processing apparatus 16B in real time.

Furthermore, multiple display units 26 and sound input/output units 30 are installed in the area (e.g., the home) where the first information processing apparatus 16A is installed. Specifically, the display units 26 are installed 360 degrees in all directions with respect to the position where the first information processing apparatus 16A is installed. The server device 12 sequentially transmits, to each of the display units 26 and the sound input/output units 30, the image data captured and the sound data acquired from the area where the second information processing apparatus 16B, which is an object remotely controlled by the first information processing apparatus 16A, is installed. Thus, the area where the first information processing apparatus 16A is installed has the same environment as that of the area where the second information processing apparatus 16B is installed (the environments in which the same images and sounds are output).

In this environment, the second information processing apparatus 16B is remotely controlled by the first information processing apparatus 16A so that it is further possible to provide reality-based information from a remote location.

The server device 12 according to the present embodiment has the hardware configuration that uses a typical computer.

The program for performing the above-described information processing executed by the server device 12 according to the present embodiment is provided by being stored, in the form of a file that is installable or executable, in a recording medium readable by a computer, such as a CD-ROM, flexible disk (FD), CD-R, or digital versatile disk (DVD).

Furthermore, a configuration may be such that the program for performing the information processing executed by the server device 12 according to the present embodiment is stored in a computer connected via a network such as the Internet and provided by being downloaded via the network. Moreover, a configuration may be such that the program for performing the information processing executed by the server device 12 according to the present embodiment is provided or distributed via a network such as the Internet.

Moreover, a configuration may be such that the program for performing the information processing executed by the server device 12 according to the present embodiment is provided such that it is installed in a ROM, or the like, in advance.

The server device 12 according to the present embodiment has a modular configuration that includes the functional unit for performing the above-described information processing. In terms of actual hardware, a CPU (processor) reads the program for performing the information processing from a storage medium and executes the read program, whereby each of the above-described functional units is loaded into a main storage device and is generated in the main storage device.

According to an aspect of the present invention, it is possible to, by using one information processing apparatus, remotely control another information processing apparatus that is a control object in an easy and simple operation.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A server device comprising:
an acquisition unit that acquires, from a first information processing apparatus that is connected via a network, identification information on a second information processing apparatus that is connected via a network and that is an object to be remotely controlled;
a storage unit that previously stores the identification information on the second information processing apparatus and stores a program for remotely controlling the second information processing apparatus that is identified by the identification information, the identification information being related to the program; and
an execution unit that executes the program that is related to the acquired identification information, wherein
the execution unit includes:
a receiving unit that receives, from the first information processing apparatus, a control signal for controlling the second information processing apparatus that is identified by the acquired identification information; and
a transmitting unit that transmits the received control signal to the second information processing apparatus that is identified by the acquired identification information.

2. The server device according to claim 1, wherein the control signal includes instruction information for causing the second information processing apparatus to execute a function that is executable by the second information processing apparatus.

3. The server device according to claim 1, wherein
the receiving unit further receives, from the second information processing apparatus, execution status information that indicates an execution status of an operation performed by the second information processing apparatus in accordance with the control signal, and
the transmitting unit transmits the execution status information to the first information processing apparatus.

4. The server device according to claim 1, wherein
the control signal includes, as the instruction information, image data that is an object to be processed by the second information processing apparatus,
the execution unit converts the image data into a data format that is processable by the second information processing apparatus, and
the transmitting unit transmits, as the received control signal, a control signal that includes, as the instruction information, the converted image data to the second information processing apparatus that is identified by the acquired identification information.

5. The server device according to claim 1, further comprising a generation unit that generates a location screen that has the second information processing apparatus located at a position that corresponds to positional information on the second information processing apparatus in a real space, wherein
the transmitting unit further transmits the location screen to the first information processing apparatus.

6. An information processing method performed by a server device, the method comprising:
acquiring, from a first information processing apparatus that is connected via a network, identification information on a second information processing apparatus that is connected via a network and that is an object to be remotely controlled; and
executing a program that is related to the acquired identification information, the program being in a storage unit that previously stores the identification information on the second information processing apparatus and stores the program for remotely controlling the second information processing apparatus that is identified by the identification information, and the identification information being related to the program,
the executing includes:
receiving, from the first information processing apparatus, a control signal for controlling the second information processing apparatus that is identified by the acquired identification information; and
transmitting the received control signal to the second information processing apparatus that is identified by the acquired identification information.

7. A computer program product comprising a non-transitory computer-readable medium having computer readable program codes, performed by a server device, the program codes when executed causing the server device to execute:
acquiring, from a first information processing apparatus that is connected via a network, identification information on a second information processing apparatus that is connected via a network and that is an object to be remotely controlled; and
executing a program that is related to the acquired identification information, the program being in a storage unit that previously stores the identification information on the second information processing apparatus and stores the program for remotely controlling the second information processing apparatus that is identified by the identification information, and the identification information being related to the program, wherein
the executing includes:
receiving, from the first information processing apparatus, a control signal for controlling the second information processing apparatus that is identified by the acquired identification information; and
transmitting the received control signal to the second information processing apparatus that is identified by the acquired identification information.
